(19) United States
(12) Patent Application Publication
(10) Pub. No.: US 2018/0201875 A1
(43) Pub. Date: Jul. 19, 2018

(54) COMPOSITIONS COMPRISING BRANCHED SULFONATED SURFACTANTS

(71) Applicant: The Procter & Gamble Company, Cincinnati, OH (US)

(72) Inventors: Patrick Christopher STENGER, Fairfield, OH (US); Phillip Kyle VINSON, Fairfield, OH (US)

(21) Appl. No.: 15/869,113

(22) Filed: Jan. 12, 2018

Related U.S. Application Data
(60) Provisional application No. 62/445,846, filed on Jan. 13, 2017.

(51) Int. Cl. C11D 1/37; C11D 1/14; C11D 1/22; C11D 11/00

(52) U.S. Cl. CPC C11D 1/37; C11D 11/0017; C11D 1/22; C11D 1/143

(57) ABSTRACT

Compositions, such as surfactant and/or detergent compositions, that include branched sulfonated surfactants. Related methods.

### FIELD OF THE INVENTION

The present disclosure relates to compositions that include branched sulfonated surfactants, and to and related methods.

### BACKGROUND OF THE INVENTION

Detergent manufacturers use various surfactants to provide cleaning benefits in their formulations, and anionic surfactants, including branched surfactants, are known to be particularly useful. Combinations of surfactants are often employed to provide desired cleaning benefits, but given the rigorous competition in the detergent marketplace, manufacturers are always looking to improve their formulations and/or process for making such formulations.

Additionally, in order to minimize transportation costs, surfactants are often concentrated. Furthermore, surfactant concentrated can be combined and diluted with other detergent ingredients or carriers to arrive at a desired level of activity. However, the chemical stability of surfactants concentrates, especially alkyl sulfate surfactants, is a concern and may require precise control of the temperature and pH environment of the surfactant concentrates in order to prevent chemical degradation. This can add additional transportation and handling costs to the surfactant concentrates. In order to minimize the transportation and handling costs of surfactants concentration, manufacturers are always looking for surfactants with a more robust chemical stability.

In short, there is a need for improved surfactant compositions, surfactant compositions with improved chemical stability profiles, and/or processes for making and using such compositions.

### SUMMARY OF THE INVENTION

The present disclosure relates to surfactant compositions comprising branched sulfonated surfactants.

More specifically, the present disclosure relates to a surfactant composition comprising: from about 5% to about 75%, by weight of the surfactant composition, of a surfactant system, the surfactant system comprising: (a) a branched surfactant of the formula X−Y, wherein X is a hydrophobic branched alkyl moiety, the alkyl moiety comprising: (1) from about 9 to about 18 total carbons, on average, in the moiety; (2) a longest linear carbon chain attached to the Y moiety, the longest linear carbon chain having, from about 8 to about 17 carbon atoms, on average; and (3) one or more, on average, alkyl moieties (“branch moieties”) branching from the longest linear carbon chain, the branch moieties having from about 1 to about 3 carbon atoms, on average; and wherein Y is a sulfonate moiety; and (b) a non-sulfonated detersive surfactant; wherein the weight ratio of (a):(b) is from about 5:95 to about 95:5.

The present disclosure further relates to a detergent composition comprising: from about 5% to about 45%, preferably from about 8% to about 30%, by weight of the detergent composition, of a surfactant system, the surfactant system comprising: (a) a branched surfactant of the formula X−Y, wherein X is a hydrophobic branched alkyl moiety, the alkyl moiety comprising: (1) from about 9 to about 18 total carbons, on average, in the moiety; (2) a longest linear carbon chain attached to the Y moiety, the longest linear carbon chain having from about 8 to about 17 carbon atoms, on average; and (3) one or more alkyl moieties (“branch moieties”) branching from the longest linear carbon chain, the branch moieties having from about 1 to about 3 carbon atoms, on average; and wherein Y is a sulfonate moiety; (b) an anionic alkyl alkoxylated sulfate surfactant; wherein the weight ratio of (a):(b) is from about 30:70 to about 70:30; and a detergent adjunct.

The present disclosure further relates to a process of making a surfactant composition, the process comprising the steps of: providing surfactants (a) and (b) as listed above, and combining (a) and (b) in a weight ratio of from about 5:95 to about 95:5, or from about 90:10 to about 10:90, or from about 75:25 to about 25:75, or from about 70:30 to about 30:70, or from about 60:40 to about 40:60, or about 50:50.

The present disclosure also relates to a process of treating a fabric, the process comprising the step of contacting a fabric with a composition as described herein, preferably in the presence of water.

The present disclosure also relates to a concentrated branched sulfonate surfactant composition comprising from about 75% to about 99%, by weight of the composition, of a branched sulfonate surfactant of the formula: X−Y, wherein X is a hydrophobic branched saturated alkyl moiety, the alkyl moiety comprising: (1) from about 9 to about 18 total carbons, on average, in the moiety; (2) a longest linear carbon chain attached to the Y moiety, the longest linear carbon chain having, from about 8 to about 17 carbon atoms, on average; and (3) one or more, on average, alkyl moieties (“branch moieties”) branching from the longest linear carbon chain, the branch moieties having from about 1 to about 3 carbon atoms, on average; and wherein Y is a sulfonate moiety.

### DETAILED DESCRIPTION OF THE INVENTION

The present disclosure relates to surfactant compositions that are useful in detergent applications, such as laundry detergents. In particular, the surfactant compositions of the present disclosure include surfactant systems that include a combination of surfactants, namely a branched sulfonate surfactant and a non-sulfonated surfactant, such as an alkyl alkoxylated sulfate surfactant, a nonionic surfactant (e.g., ethoxylated alcohol), an amphoteric surfactant, a cationic surfactant, and/or a zwitterionic surfactant, in particular ratios.

It has been surprisingly found that such surfactants in particular ratios provide improved cleaning properties compared to comparable surfactant systems. In particular, it has been surprisingly found that such surfactant systems exhibit superior cleaning properties when compared to systems that include branched sulfate surfactants or linear alkyl benzene sulfonate surfactants in combination with other surfactants, as well as when compared to the individual surfactants themselves. Without wishing to be bound by theory, it is believed that the branched sulfonates perform synergistically with non-sulfonated surfactants due to the way the surfactant headgroups pack at the oil-water interface.

The compositions and related methods are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein with regard to alkyl moieties and/or chain lengths, the term “average” is often reported by surfactant suppliers. This corresponds to the chainlength distribution on a mass basis is the following way: Alcohol Average Alkyl Carbon Chainlength=ΣCLᵢ/Σ(Xᵢ/CLᵢ) where Xᵢ is the mass fraction of each chainlength, CLᵢ unless otherwise stated.

As used herein with regard to degrees of alkoxylation, the term “average” means average number of moles of alkoxy groups per moles of surfactant or alcohol, unless otherwise stated.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Surfactant Composition

The present disclosure relates to surfactant compositions that comprise surfactant systems. The surfactant compositions may be processing intermediates, such as upstream concentrated pastes, or they may be final products, such as fully-formulated laundry detergents. The surfactant compositions may be fabric care compositions. The compositions may be used as a pre-laundering treatment or during the wash cycle.

The surfactant compositions may have any desired form, including, for example, a form selected from liquid, powder, single-phase or multi-phase unit dose, pouch, tablet, gel, paste, bar, or flake.

The surfactant composition may be selected from the group of light duty liquid detergents compositions, heavy duty liquid detergent compositions, hard surface cleaning compositions (such as hand or automatic dishwashing compositions), detergent gels commonly used for laundry, laundry additives, fabric enhancer compositions, and mixtures thereof. The surfactant composition may be a detergent composition, such as a hard surface cleaning composition (such as a dishwashing composition) or a fabric care composition (such as a heavy duty liquid detergent composition).

The surfactant composition may be a liquid laundry detergent. The liquid laundry detergent composition may have a viscosity from about 1 to about 2000 centipoise (1-2000 mPa⋅s), or from about 200 to about 800 centipoise (200-800 mPa⋅s). The viscosity is determined using a Brookfield viscometer, No. 2 spindle, at 60 RPM/s, measured at 25° C.

The laundry detergent composition may be a solid laundry detergent composition, and may be a free-flowing particulate laundry detergent composition (i.e., a granular detergent product).

The fabric care composition may be in unit dose form. A unit dose article is intended to provide a single, easy to use dose of the composition contained within the article for a particular application. The unit dose form may be a pouch or a water-soluble sheet. A pouch may comprise at least one, or at least two, or at least three compartments. Typically, the composition is contained in at least one of the compartments. The compartments may be arranged in superposed orientation, i.e., one positioned on top of the other, where they may share a common wall. At least one compartment may be superposed on another compartment. Alternatively, the compartments may be positioned in a side-by-side orientation, i.e., one orientated next to the other. The compartments may even be orientated in a ‘tire and rim’ arrangement, i.e., a first compartment is positioned next to a second compartment, but the first compartment at least partially surrounds the second compartment, but does not completely enclose the second compartment. Alternatively, one compartment may be completely enclosed within another compartment.

The unit dose form may comprise water-soluble film that forms the compartment and encapsulates the detergent composition. Preferred film materials are polymeric materials; for example, the water-soluble film may comprise polyvinyl alcohol. The film material can, for example, be obtained by casting, blow-moulding, extrusion, or blown extrusion of the polymeric material, as known in the art. Suitable films are those supplied by Monosol (Merrillville, Ind., USA) under the trade references M8630, M8900, M8779, and M8310, and PVOH films of corresponding solubility and deformability characteristics.

When the surfactant composition is a liquid, the surfactant composition typically comprises water. The composition may comprise from about 1% to about 80%, by weight of the composition, water. When the composition is a heavy duty liquid detergent composition, the composition typically comprises from about 40% to about 80% water. When the composition is a compact liquid detergent, the composition typically comprises from about 20% to about 60%, or from about 30% to about 50% water. When the composition is in unit dose form, for example, encapsulated in water-soluble film, the composition typically comprises less than 20%, or less than 15%, or less than 12%, or less than 10%, or less than 8%, or less than 5% water. The composition may comprise from about 1% to 20%, or from about 3% to about 15%, or from about 5% to about 12%, by weight of the composition, water.

### Surfactant System

The compositions and processes of the present disclosure relate to surfactant systems. The surfactant systems include a mixture of surfactants.

The compositions of the present disclosure may comprise from about 5% to about 75%, by weight of the surfactant composition, of a surfactant system. The compositions may comprise from about 40% to about 75%, by weight of the surfactant composition, of the surfactant system;

such levels are particularly suitable for compact detergents, compositions suitable for unit dose articles, or concentrated surfactant compositions suitable for upstream usage, for example. The compositions may comprise from about 5% to about 50%, preferably from about from about 8% to about 30%, by weight of the surfactant composition, of the surfactant system; such levels are particularly suitable for compact detergents, compositions suitable for unit dose articles, or heavy duty liquid detergents, for example.

The surfactant systems of the present disclosure include, at least, (a) a branched sulfonate surfactant and (b) a non-sulfonated surfactant, such as an alkyl alkoxylated sulfate surfactant, a nonionic surfactant (e.g., ethoxylated alcohol), an amphoteric surfactant, a cationic surfactant, and/or a zwitterionic surfactant, in particular ratios. The surfactant systems may include (c) additional surfactant. These surfactants are described in more detail below.

The compositions of the present disclosure include the branched sulfonate surfactant (a) and the non-sulfonated detersive surfactant (b) in a weight ratio. The weight ratio of (a) to (b) may be from about 5:95 to about 95:5, or from about 10:90 to about 90:10, or from about 30:70 to about 70:30, or from about 40:60 to about 60:40, or about 50:50. The weight ratio of (a) to (b) may be at least about 5:95, or at least about 10:90, or at least about 30:70, or at least about 40:60. The weight ratio of (a) to (b) may be up to about 95:5, or up to about 90:10, or up to about 70:30, or up to about 60:40. Typically, the relative amount of the non-sulfonated detersive surfactant (b) in the ratio of (a) to (b) is determined as the relative amount of a particular surfactant, rather than all of the non-sulfonated surfactants in the surfactant system. For example, if a surfactant system comprises a branched sulfonate surfactant according to the present disclosure, AES, and non-ionic surfactant, the ratio of (a) to (b) may be understood as the amount of branched sulfonate surfactant to AES or the amount of branched sulfonate surfactant to nonionic surfactant, but is typically not understood as the amount of branched sulfonate surfactant to the total amount of remaining surfactant (e.g., the amount of AES plus the amount of nonionic surfactant).

(a) Branched Sulfonated Surfactant

The compositions of the present disclosure comprise a branched sulfonated surfactant. The branched sulfonated surfactant may be present at a level of from about 1%, or from about 2%, or from about 5%, or from about 8%, or from about 10%, to about 72%, or to about 60%, or to about 50%, or to about 40%, or to about 30%, or to about 25%, or to about 20%, or to about 15%, or to about 12%, or to about 10%, by weight of the composition. The branched sulfonated surfactant may be present at a level of from about 5%, or from about 10%, or from about 20%, or from about 30%, or from about 40%, or about 50%, to about 95%, or to about 90%, or to about 80%, or to about 70%, or to about 60%, or to about 50%, by weight of the surfactant system.

The branched sulfonate surfactant may be a branched surfactant. The branched surfactant may be of the formula:

X−Y

wherein X is a hydrophobic branched saturated alkyl moiety, the alkyl moiety comprising: (1) from about 9 to about 18 total carbons, on average, in the moiety; (2) a longest linear carbon chain attached to the Y moiety, the longest linear carbon chain having, from about 8 to about 17 carbon atoms, on average; and (3) one or more, on average, alkyl moieties (“branch moieties”) branching from the longest linear carbon chain, the branch moieties having from about 1 to about 3 carbon atoms, on average; and wherein Y is a sulfonate moiety.

It is understood that the branched sulfonate surfactants of the present disclosure may be presented as a mixture or distribution of surfactant molecules. As discussed above, an “average” refers to the weight average of the mixture or distribution of surfactant molecules. It is further understood that some of the “branched” sulfonate surfactant molecules may have zero branched moieties (and therefore will technically not be “branched”). However, for the purposes of determining the averages and/or percentages levels described herein, such molecules are to be included in the appropriate calculation or determination.

The longest linear carbon chain in the -X moiety (“(2)”) may have from about 10 to about 17 carbons, preferably from about 12 to about 17 carbons, more preferably from about 14 to about 17 carbons. The longest linear carbon chain in the -X moiety (“(2)”) may have an average number of carbons that is from 12 to 13, from 14 to 15, or from 16 to 17. The longest linear carbon chain in the -X moiety (“(2)”) is typically a saturated carbon chain.

The branch moieties (“(3)”) may from about 1 to about 2.5, preferably from about 1 to about 2, more preferably from about 1.5 to about 2, carbons on average. A majority of the branch moieties may be methyl groups.

At least one of the branch moieties may be attached directly to a carbon of the longest linear carbon chain located at position 2 or greater, wherein the carbon at position 1 (“C1”) is the carbon of the longest linear carbon chain attached to the -Y moiety. C1 is typically a primary carbon. At least one of the branch moieties may be attached directly to a carbon of the longest linear carbon chain located at a position in the range of from position 2 to position (ω−2), wherein the terminal carbon of the longest linear carbon chain is at positon ω.

In addition to the branch moieties, the X- moiety may be substituted or unsubstituted. In some embodiments, the X- moiety is not substituted with a sulphonate group. In some embodiments, the X- moiety is not substituted with a non-alkyl group. The X- moiety may be substantially free of geminally-substituted carbon atoms.

As stated above, it is understood that some of the “branched” sulfonate surfactant molecules of a given sample may include zero branch moieties. However, typically a certain minimum of surfactant molecules that include one or more branch moieties is desired. The branched sulfonate surfactant may include at least about 30%, or at least about 40%, or at least about 50%, or at least about 60%, or at least about 70%, or at least about 80%, or at least about 90%, by weight of the branched sulfonate surfactant, of branched sulfonate surfactant that includes branch moieties.

The branched sulfonate surfactants according to the present disclosure may include X-moieties according to and/or derived from the following.

The branched surfactant may comprise a longer alkyl chain, branched surfactant compound of the above formula wherein the X- moiety is a branched primary alkyl moiety having the formula:

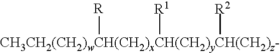

wherein the total number of carbon atoms in the branched primary alkyl moiety of this formula (including the R, R¹, and R² branching) is from 11 to 19; R, R1, and R2 are each independently selected from hydrogen and C1-C3 alkyl (typically methyl), provided R, R1, and R2 are not all hydrogen and, when z is 0, at least R or R1 is not hydrogen; w is an integer from 0 to 13; x is an integer from 0 to 13; y is an integer from 0 to 13; z is an integer from 0 to 13; and w+x+y+z is from 5 to 13.

The branched surfactant may comprise a longer alkyl chain, branched surfactant compound of the above formula wherein the X- moiety is a branched primary alkyl moiety having the formula selected from:

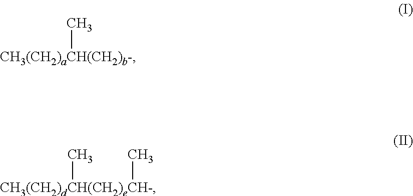

or mixtures thereof; wherein a, b, d, and e are integers, a+b is from 8 to 16, d+e is from 6 to 14 and wherein further
when a+b=8, a is an integer from 2 to 7 and b is an integer from 1 to 6;
when a+b=9, a is an integer from 2 to 8 and b is an integer from 1 to 7;
when a+b=10, a is an integer from 2 to 9 and b is an integer from 1 to 8;
when a+b=11, a is an integer from 2 to 10 and b is an integer from 1 to 9;
when a+b=12, a is an integer from 2 to 11 and b is an integer from 1 to 10;
when a+b=13, a is an integer from 2 to 12 and b is an integer from 1 to 11;
when a+b=14, a is an integer from 2 to 13 and b is an integer from 1 to 12;
when a+b=15, a is an integer from 2 to 14 and b is an integer from 1 to 13;
when a+b=16, a is an integer from 2 to 15 and b is an integer from 1 to 14;
when d+e=6, d is an integer from 2 to 5 and e is an integer from 1 to 4;
when d+e=7, d is an integer from 2 to 6 and e is an integer from 1 to 5;
when d+e=8, d is an integer from 2 to 7 and e is an integer from 1 to 6;
when d+e=9, d is an integer from 2 to 8 and e is an integer from 1 to 7;
when d+e=10, d is an integer from 2 to 9 and e is an integer from 1 to 8;
when d+e=11, d is an integer from 2 to 10 and e is an integer from 1 to 9;
when d+e=12, d is an integer from 2 to 11 and e is an integer from 1 to 10;
when d+e=13, d is an integer from 2 to 12 and e is an integer from 1 to 11;
when d+e=14, d is an integer from 2 to 13 and e is an integer from 1 to 12.

In the branched surfactant compounds described above, certain points of branching (e.g., the location along the chain of the R, R¹, and/or R² moieties in the above formula) are preferred over other points of branching along the backbone of the surfactant. Mid-chain branched surfactants may be preferred. The formula below illustrates the mid-chain branching range (i.e., where points of branching occur), preferred mid-chain branching range, and more preferred mid-chain branching range for mono-methyl branched alkyl X- moieties.

For mono-methyl substituted surfactants, these ranges exclude the two terminal carbon atoms of the chain and the carbon atom immediately adjacent to the -Y group.

The formula below illustrates a mid-chain branching range, preferred mid-chain branching range, and more preferred mid-chain branching range for di-methyl substituted alkyl X- moieties.

The branched anionic surfactant may comprise a C12/13 alcohol-based surfactant comprising a methyl branch randomly distributed along the hydrophobe chain, e.g., Safol®, Marlipal® available from Sasol.

Further suitable branched anionic detersive surfactants may include surfactants derived from alcohols branched in the 2-alkyl position (where the sulfonate group is eventually attached at the 1-alkyl or C1 position), such as those sold under the trade names Isalchem®123, Isalchem®125, Isalchem®145, Isalchem®167, which are derived from the oxo process. Due to the oxo process, the branching is situated in the 2-alkyl position. These 2-alkyl branched alcohols are typically in the range of C11 to C14/C15 in length and comprise structural isomers that are all branched in the 2-alkyl position. Other suitable 2-alkyl alcohols may include those sold under the Lial® and Neodol® tradenames. The branched sulfonates of the present disclosure may be, in at least some cases, not derived primarily from alcohols branched in the 2-alkyl positions. Such branched sulfonates may or may not be present in the composition.

Additional suitable branched anionic detersive surfactants may include surfactant derivatives of isoprenoid-based polybranched detergent alcohols. Isoprenoid-based surfactants and isoprenoid derivatives are also described in the book entitled “Comprehensive Natural Products Chemistry: Isoprenoids Including Carotenoids and Steroids (Vol. two)”, Barton and Nakanishi,© 1999, Elsevier Science Ltd and are included in the structure E, and are hereby incorporated by reference.

Further suitable branched anionic detersive surfactants may include those derived from anteiso and iso-alcohols.

Suitable branched anionic surfactants may also include Guerbet-alcohol-based surfactants. Guerbet alcohols are branched, primary monofunctional alcohols that have two linear carbon chains with the branch point always at the second carbon position. Guerbet alcohols are chemically described as 2-alkyl-1-alkanols. Guerbet alcohols generally have from 12 carbon atoms to 36 carbon atoms. The Guerbet alcohols may be represented by the following formula: (R1)(R2)CHCH₂OH, where R1 is a linear alkyl group, R2 is a linear alkyl group, the sum of the carbon atoms in R1 and R2 is 10 to 34, and both R1 and R2 are present. Guerbet alcohols are commercially available from Sasol as Isofol® alcohols, from Cognis as Guerbetol, and from Shell as Neodol® 67.

In the branched sulfonate surfactants of the present disclosure, Y is a sulfonate moiety, typically connected to a primary carbon on the X- group (C1). Y may be an alkoxylated or a non-alkoxylated moiety. A sample of the branched sulfonate surfactant described herein may include some surfactants having alkoxylated moieties and some surfactants having non-alkoxylated moieties. Y may be a non-alkoxylated sulfonate moiety.

(b) Non-Sulfonated Detersive Surfactant

The compositions of the present disclosure comprise a non-sulfonated detersive surfactant. The non-sulfonated surfactant may be present at a level of from about 1%, or from about 2%, or from about 5%, or from about 8%, or from about 10%, to about 72%, or to about 60%, or to about 50%, or to about 40%, or to about 30%, or to about 25%, or to about 20%, or to about 15%, or to about 12%, or to about 10%, by weight of the composition. The non-sulfonated surfactant may be present at a level of from at a level of from about 5%, or from about 10%, or from about 20%, or from about 30%, or from about 40%, or about 50%, to about 95%, or to about 90%, or to about 80%, or to about 70%, or to about 60%, or to about 50%, by weight of the surfactant system.

The non-sulfonated surfactant may be selected from the group consisting of anionic surfactant, nonionic surfactant, amphoteric surfactant, cationic surfactant, zwitterionic surfactant, and mixtures thereof. The non-sulfonated detersive surfactant may be selected from the group consisting of alkyl alkoxylated sulfate surfactant, ethoxylated alcohol surfactant, amine oxide surfactant, quaternary ammonium surfactants, betaine surfactant, and mixtures thereof. The non-sulfonated detersive surfactant may be selected from the group consisting of alkyl alkoxylated sulfate surfactant, ethoxylated alcohol surfactant, amine oxide, and mixtures thereof.

The non-sulfonated surfactant may be an anionic surfactant. The anionic surfactant may be a sulfate detersive surfactant, e.g., alkoxylated and/or non-alkoxylated alkyl sulfate material.

The anionic surfactant may be alkyl alkoxylated sulfate surfactant. The anionic alkyl alkoxylated sulfate surfactant may be an alkyl ethoxylated sulfate surfactant, also known as alkyl ether sulfates or alkyl polyethoxylate sulfates. Examples of alkyl ethoxylated sulfates include water-soluble salts, particularly the alkali metal, ammonium and alkylolammonium salts, of organic sulfuric reaction products having in their molecular structure an alkyl group containing from about 8 to about 30 carbon atoms and a sulfonic acid and its salts. (Included in the term “alkyl” is the alkyl portion of acyl groups. The alkyl group may contain from about 15 carbon atoms to about 30 carbon atoms. The alkyl ether sulfate surfactant may be a mixture of alkyl ether sulfates, said mixture having an average (arithmetic mean) carbon chain length within the range of about 12 to 30 carbon atoms, and or an average carbon chain length of about 25 carbon atoms, and an average (arithmetic mean) degree of ethoxylation of from about 1 mol to 4 mols of ethylene oxide, and or an average (arithmetic mean) degree of ethoxylation of 1.8 mols of ethylene oxide. The alkyl ether sulfate surfactant may have a carbon chain length between about 10 carbon atoms to about 18 carbon atoms, and a degree of ethoxylation of from about 1 to about 6 mols of ethylene oxide.

Non-ethoxylated alkyl sulfates may also be added to the disclosed cleaning compositions and used as an anionic surfactant component. Examples of non-alkoxylated, e.g., non-ethoxylated, alkyl sulfate surfactants include those produced by the sulfation of higher C₈-C₂₀ fatty alcohols. Primary alkyl sulfate surfactants may have the general formula: ROSO₃⁻M⁺, wherein R is typically a linear C₈-C₂₀ hydrocarbyl group, which may be straight chain or branched chain, and M is a water-solubilizing cation. In some examples, R is a C₁₀-C₁₅ alkyl, and M is an alkali metal. In other examples, R is a C₁₂-C₁₄ alkyl and M is sodium.

Ethoxylated or non-ethoxylated sulfate surfactants can be formed by the sulfation of alcohols that include alkyl chains.

The non-sulfonated surfactant may be a nonionic surfactant. The nonionic surfactant may be an ethoxylated alcohol surfactant and/or ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15.

The nonionic surfactant may be an ethoxylated alcohol. For example, the nonionic surfactant may be selected from ethoxylated alcohols having an average of about 12-14 carbon atoms in the alcohol (alkyl) portion and an average degree of ethoxylation of about 7-9 moles of ethylene oxide per mole of alcohol.

Other non-limiting examples of nonionic surfactants may include: C₁₂-C₁₈ alkyl ethoxylates, such as, NEODOL® nonionic surfactants from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, as discussed in U.S. Pat. No. 6,150,322; C₁₄-C₂₂ mid-chain branched alkyl alkoxylates, BAEₓ, wherein x is from 1 to 30; alkylpolysaccharides, specifically alkylpolyglycosides; polyhydroxy fatty acid amides; and ether capped poly(oxyalkylated) alcohol surfactants.

The non-sulfonated surfactant may be an amphoteric surfactant. The amphoteric surfactant may be amine oxide surfactant. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3)O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on t he alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein.

The amine oxide may further comprise two moieties, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a C1 alkyl.

The non-sulfonated surfactant may be a cationic surfactant. Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium surfactants; dimethyl hydroxyethyl lauryl ammonium chloride; polyamine cationic surfactants; cationic ester surfactants; and amino surfactants, such as amido propyldimethyl amine (APA). The compositions of the present disclosure may be substantially free of cationic surfactants and/or of surfactants that become cationic below a pH of 7 or below a pH of 6, as cationic surfactants may negatively interact with other components, such as anionic surfactants.

The non-sulfonated surfactant may be a zwitterionic surfactant. Examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. The zwitterionic surfactants may comprise betaines, including alkyl dimethyl betaine, cocodimethyl amidopropyl betaine, and C₈ to C₁₈ (for example from C₁₂ to C₁₈) amine oxide and sulfo and hydroxy betaines, such as N-alkyl-N,N-dimethylammino-1-propane sulfonate where the alkyl group can be from C₈ to C₁₈ or from C₁₀ to C₁₄.

The non-sulfonated surfactant may be a branched surfactant. Suitable branched surfactant may comprise a non-sulfonated C12/13 alcohol-based surfactant comprising a methyl branch randomly distributed along the hydrophobe chain, e.g., Safol®, Marlipal® available from Sasol. Further suitable additional branched anionic detersive surfactants include non-sulfonated surfactants derived from alcohols branched in the 2-alkyl position, such as those sold under the trade names Isalchem®123, Isalchem®125, Isalchem®145, Isalchem®167, which are derived from the oxo process. Due to the oxo process, the branching is situated in the 2-alkyl position. These 2-alkyl branched alcohols are typically in the range of C11 to C14/C15 in length and comprise structural isomers that are all branched in the 2-alkyl position. Additional suitable non-sulfonated branched anionic detersive surfactants may include surfactant derivatives of isoprenoid-based polybranched detergent alcohols; branched surfactants derived from anteiso and iso-alcohols; and/or Guerbet-alcohol-based surfactants.

(c) Additional Sulfonated Surfactant

The composition and/or surfactant system may further comprise one or more additional sulfonated surfactants.

The surfactant compositions of the present disclosure may further comprise alkyl benzene sulfonate surfactant. The alkyl group may contain from about 9 to about 15 carbon atoms, in straight chain (linear) or branched chain configuration. The alkyl group may be linear. Such linear alkylbenzene sulfonates are known as “LAS.” The linear alkylbenzene sulfonate may have an average number of carbon atoms in the alkyl group of from about 11 to 14. The linear straight chain alkyl benzene sulfonates may have an average number of carbon atoms in the alkyl group of about 11.8 carbon atoms, which may be abbreviated as C11.8 LAS. The alkyl benzene sulfonate may be present, at least partly, as a salt, such as an alkali metal salt, preferably a sodium salt, or an amine salt, such as an ethanolamine salt, e.g., an monoethanolamine salt.

Suitable alkyl benzene sulphonate (LAS) may be obtained by sulphonating commercially available linear alkyl benzene (LAB). Suitable LAB includes low 2-phenyl LAB, such as those supplied by Sasol under the tradename Isochem® or those supplied by Petresa under the tradename Petrelab®. Other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as those catalyzed by hydrofluoric acid (HF), may also be suitable.

Other anionic surfactants useful herein are the water-soluble salts of: paraffin sulfonates and secondary alkane sulfonates containing from about 8 to about 24 (and in some examples about 12 to 18) carbon atoms; alkyl glyceryl ether sulfonates, especially those ethers of C₈₋₁₈ alcohols (e.g., those derived from tallow and coconut oil). Mixtures of the alkylbenzene sulfonates with the above-described paraffin sulfonates, secondary alkane sulfonates and alkyl glyceryl ether sulfonates are also useful.

The additional surfactant may comprise an additional branched surfactant that does not fall into category (a) and/or (b) described above. For example, the additional branched surfactant may comprise modified alkylbenzene sulfonate (MLAS).

### Detergent Adjuncts

The surfactant composition may further comprise at least one detergent adjunct. The detergent adjunct(s) may be present in the composition at levels suitable for the intended use of the composition. Typical usage levels range from as low as 0.001% by weight of composition for adjuncts such as optical brighteners to 50% by weight of composition for builders.

The at least one detergent adjunct may be selected from the group consisting of fatty acids and/or salts thereof, enzymes, encapsulated benefit agents, soil release polymers, hueing agents, builders, chelating agents, dye transfer inhibiting agents, dispersants, enzyme stabilizers, catalytic materials, bleaching agents, bleach catalysts, bleach activators, polymeric dispersing agents, soil removal/anti-redeposition agents, polymeric dispersing agents, polymeric grease cleaning agents, brighteners, suds suppressors, dyes, hueing agents, perfume, structure elasticizing agents, fabric softeners, carriers, fillers, hydrotropes, solvents, anti-microbial agents and/or preservatives, neutralizers and/or pH adjusting agents, processing aids, fillers, rheology modifiers or structurants, opacifiers, pearlescent agents, pigments, anti-corrosion and/or anti-tarnishing agents, and mixtures thereof.

The at least one detergent adjunct may include external structuring systems, enzymes, encapsulated benefit agents such as encapsulated perfume, soil release polymers, hueing agents, and mixtures thereof. These adjuncts are described in more detail below.

External Structuring System

When the detergent composition is a liquid composition, the detergent composition may comprise an external structuring system. The structuring system may be used to provide sufficient viscosity to the composition in order to provide, for example, suitable pour viscosity, phase stability, and/or suspension capabilities.

The composition of the present disclosure may comprise from 0.01% to 5% or even from 0.1% to 1% by weight of an external structuring system. The external structuring system may be selected from the group consisting of:
(i) non-polymeric crystalline, hydroxy-functional structurants and/or
(ii) polymeric structurants.

Such external structuring systems may be those which impart a sufficient yield stress or low shear viscosity to stabilize a fluid laundry detergent composition independently from, or extrinsic from, any structuring effect of the detersive surfactants of the composition. They may impart to a fluid laundry detergent composition a high shear viscosity at 20 s⁻¹ at 21° C. of from 1 to 1500 cps and a viscosity at low shear (0.05 s⁻¹ at 21° C.) of greater than 5000 cps. The viscosity is measured using an AR 550 rheometer from TA instruments using a plate steel spindle at 40 mm diameter and a gap size of 500 μm. The high shear viscosity at 20 s⁻¹ and low shear viscosity at 0.5 s⁻¹ can be obtained from a logarithmic shear rate sweep from 0.1 s⁻¹ to 25 s⁻¹ in 3 minutes time at 21° C.

In one embodiment, the compositions may comprise from about 0.01% to about 1% by weight of a non-polymeric crystalline, hydroxyl functional structurant. Such non-polymeric crystalline, hydroxyl functional structurants may comprise a crystallizable glyceride which can be pre-emulsified to aid dispersion into the final unit dose laundry detergent composition. Suitable crystallizable glycerides include hydrogenated castor oil or “HCO” or derivatives thereof, provided that it is capable of crystallizing in the liquid detergent composition.

The detergent composition may comprise from about 0.01% to 5% by weight of a naturally derived and/or synthetic polymeric structurant. Suitable naturally derived polymeric structurants include: hydroxyethyl cellulose, hydrophobically modified hydroxyethyl cellulose, carboxymethyl cellulose, polysaccharide derivatives and mixtures thereof. Suitable polysaccharide derivatives include: pectine, alginate, arabinogalactan (gum Arabic), carrageenan, gellan gum, xanthan gum, guar gum and mixtures thereof. Suitable synthetic polymeric structurants include: polycarboxylates, polyacrylates, hydrophobically modified ethoxylated urethanes, hydrophobically modified non-ionic polyols and mixtures thereof. In one aspect, the polycarboxylate polymer may be a polyacrylate, polymethacrylate or mixtures thereof. In another aspect, the polyacrylate may be a copolymer of unsaturated mono- or di-carbonic acid and C₁-C₃₀ alkyl ester of the (meth)acrylic acid. Such copolymers are available from Noveon inc under the tradename Carbopol® Aqua 30.

Enzymes

The cleaning compositions of the present disclosure may comprise enzymes. Enzymes may be included in the cleaning compositions for a variety of purposes, including removal of protein-based, carbohydrate-based, or triglyceride-based stains from substrates, for the prevention of refugee dye transfer in fabric laundering, and for fabric restoration. Suitable enzymes include proteases, amylases, lipases, carbohydrases, cellulases, oxidases, peroxidases, mannanases, and mixtures thereof of any suitable origin, such as vegetable, animal, bacterial, fungal, and yeast origin. Other enzymes that may be used in the cleaning compositions described herein include hemicellulases, gluco-amylases, xylanases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidases, chondroitinases, laccases, or mixtures thereof. Enzyme selection is influenced by factors such as pH-activity and/or stability optima, thermostability, and stability to active detergents, builders, and the like.

In some aspects, lipase may be included. Additional enzymes that may be used in certain aspects include mannanase, protease, and cellulase. Mannanase, protease, and cellulase may be purchased under the trade names, respectively, Mannaway, Savinase, and Celluclean, from Novozymes (Denmark), providing, respectively, 4 mg, 15.8 mg, and 15.6 mg active enzyme per gram.

In some aspects, the composition comprises at least two, or at least three, or at least four enzymes. In some aspects, the composition comprises at least an amylase and a protease.

Enzymes are normally incorporated into cleaning compositions at levels sufficient to provide a “cleaning-effective amount.” The phrase “cleaning effective amount” refers to any amount capable of producing a cleaning, stain removal, soil removal, whitening, deodorizing, or freshness improving effect on soiled material such as fabrics, hard surfaces, and the like. In some aspects, the detergent compositions may comprise from about 0.0001% to about 5%, or from about 0005% to about 3%, or from about 0.001% to about 2%, of active enzyme by weight of the cleaning composition. The enzymes can be added as a separate single ingredient or as mixtures of two or more enzymes.

Encapsulated Benefit Agents

In some aspects, the composition disclosed herein may comprise encapsulated benefit agents. The encapsulated benefit agents may comprise a suitable benefit agent such as perfume raw materials, silicone oils, waxes, hydrocarbons, higher fatty acids, essential oils, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, antioxidants, chelants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers, anti-foaming agents, UV protection agents, sun fade inhibitors, anti-allergenic agents, enzymes, water proofing agents, fabric comfort agents, shrinkage resistance agents, stretch resistance agents, stretch recovery agents, skin care agents, glycerin, and natural actives, antibacterial actives, antiperspirant actives, cationic polymers, dyes and mixtures thereof. In some aspects, the encapsulated benefit agent is encapsulated perfume as described below.

In some aspects, the compositions disclosed herein may comprise a perfume delivery system. Such perfume delivery system may be an encapsulated benefit agent comprising perfume. The encapsulate may comprise a core that comprises perfume and a shell, with the shell encapsulating the core. The shell may comprise a material selected from the group consisting of aminoplast copolymer, an acrylic, an acrylate, and mixtures thereof. The aminoplast copolymer may be melamine-formaldehyde, urea-formaldehyde, cross-linked melamine formaldehyde, or mixtures thereof. In some aspects, the shell comprises a material selected from the group consisting of a polyacrylate, a polyethylene glycol acrylate, a polyurethane acrylate, an epoxy acrylate, a polymethacrylate, a polyethylene glycol methacrylate, a polyurethane methacrylate, an epoxy methacrylate and mixtures thereof. The perfume microcapsule's shell may be coated with one or more materials, such as a polymer, that aids in the deposition and/or retention of the perfume microcapsule on the site that is treated with the composition disclosed herein. The polymer may be a cationic polymer selected from the group consisting of polysaccharides, cationically modified starch, cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides, imidazolium halides, poly vinyl amine, copolymers of poly vinyl amine and N-vinyl formamide, and mixtures thereof. Typically, the core comprises raw perfume oils. The perfume microcapsule may be friable and/or have a mean particle size of from about 10 microns to about 500 microns or from about 20 microns to about 200 microns. In some aspects, the composition comprises, based on total composition weight, from about 0.01% to about 80%, or from about 0.1% to about 50%, or from about 1.0% to about 25%, or from about 1.0% to about 10% of perfume microcapsules. Suitable capsules may be obtained from Appleton Papers Inc., of Appleton, Wis. USA.

Formaldehyde scavengers may also be used in or with such perfume ecapsulates. Suitable formaldehyde scavengers may include: sodium bisulfite, urea, cysteine, cysteamine, lysine, glycine, serine, carnosine, histidine, glutathione, 3,4-diaminobenzoic acid, allantoin, glycouril, anthranilic acid, methyl anthranilate, methyl 4-aminobenzoate, ethyl acetoacetate, acetoacetamide, malonamide, ascorbic acid, 1,3-dihydroxyacetone dimer, biuret, oxamide, benzoguanamine, pyroglutamic acid, pyrogallol, methyl gallate, ethyl gallate, propyl gallate, triethanol amine, succinamide, thiabendazole, benzotriazol, triazole, indoline, sulfanilic acid, oxamide, sorbitol, glucose, cellulose, poly(vinyl alcohol), poly(vinyl amine), hexane diol, ethylenediamine-N,N′-bisacetoacetamide, N-(2-ethylhexyl)acetoacetamide, N-(3-phenylpropyl)acetoacetamide, lilial, helional, melonal, triplal, 5,5-dimethyl-1,3-cyclohexanedione, 2,4-dimethyl-3-cyclohexenecarboxaldehyde, 2,2-dimethyl-1,3-dioxan-4,6-dione, 2-pentanone, dibutyl amine, triethylenetetramine, benzylamine, hydroxycitronellol, cyclohexanone, 2-butanone, pentane dione, dehydroacetic acid, chitosan, or a mixture thereof.

Soil Release Polymers (SRPs)

The detergent compositions of the present disclosure may comprise a soil release polymer. In some aspects, the detergent compositions may comprise one or more soil release polymers having a structure as defined by one of the following structures (I), (II) or (III):
(I) —[(OCHR¹-CHR²)ₐ—O—OC—Ar—CO—]_{d}
(II) —[(OCHR³-CHR⁴)_{b}—O—OC-sAr—CO—]ₑ
(III) —[(OCHR⁵-CHR⁶)_{c}—OR⁷]_{f}
   wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴, R⁵ and R⁶ are independently selected from H or C₁-C₁₈ n- or iso-alkyl; and
R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN300 and SRN325 supplied by Clariant. Other suitable soil release polymers are Marloquest polymers, such as Marloquest SL supplied by Sasol.

Hueing Agents

The compositions may comprise a fabric hueing agent (sometimes referred to as shading, bluing or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents may include dyes, dye-clay conjugates, and organic and inorganic pigments. Suitable dyes include small molecule dyes and polymeric dyes. Suitable small molecule dyes include small molecule dyes selected from the group consisting of dyes falling into the Colour Index (C.I.) classifications of Direct, Basic, Reactive or hydrolysed Reactive, Solvent or Disperse dyes for example that are classified as Blue, Violet, Red, Green or

Black, and provide the desired shade either alone or in combination. In another aspect, suitable small molecule dyes include small molecule dyes selected from the group consisting of Colour Index (Society of Dyers and Colourists, Bradford, UK) numbers Direct Violet dyes such as 9, 35, 48, 51, 66, and 99, Direct Blue dyes such as 1, 71, 80 and 279, Acid Red dyes such as 17, 73, 52, 88 and 150, Acid Violet dyes such as 15, 17, 24, 43, 49 and 50, Acid Blue dyes such as 15, 17, 25, 29, 40, 45, 75, 80, 83, 90 and 113, Acid Black dyes such as 1, Basic Violet dyes such as 1, 3, 4, 10 and 35, Basic Blue dyes such as 3, 16, 22, 47, 66, 75 and 159, Disperse or Solvent dyes such as those described in EP1794275 or EP1794276, or dyes as disclosed in US 7208459 B2, and mixtures thereof. In another aspect, suitable small molecule dyes include small molecule dyes selected from the group consisting of C. I. numbers Acid Violet 17, Direct Blue 71, Direct Violet 51, Direct Blue 1, Acid Red 88, Acid Red 150, Acid Blue 29, Acid Blue 113 or mixtures thereof.

Suitable polymeric dyes may include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Polymeric dyes include those described in WO2011/98355, WO2011/47987, US2012/090102, WO2010/145887, WO2006/055787 and WO2010/142503.

Suitable polymeric dyes may also include include polymeric dyes selected from the group consisting of fabric-substantive colorants sold under the name of Liquitint® (Milliken,

Spartanburg, South Carolina, USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

Suitable dye clay conjugates may include dye clay conjugates selected from the group comprising at least one cationic/basic dye and a smectite clay, and mixtures thereof. In another aspect, suitable dye clay conjugates include dye clay conjugates selected from the group consisting of one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11, and a clay selected from the group consisting of Montmorillonite clay, Hectorite clay, Saponite clay and mixtures thereof. In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red R1 C.I. 45160 conjugate, Montmorillonite

C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red R1 C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green G1 C.I. 42040 conjugate, Saponite Basic Red R1 C.I. 45160 conjugate, Saponite C.I. Basic Black 2 conjugate and mixtures thereof.

Suitable pigments may include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C1-C3 -alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof.

In another aspect, suitable pigments include pigments selected from the group consisting of Ultramarine Blue (C.I. Pigment Blue 29), Ultramarine Violet (C.I. Pigment Violet 15) and mixtures thereof.

The aforementioned fabric hueing agents can be used in combination (e.g., any suitable mixture of fabric hueing agents can be used).

Concentrated Branched Sulfonate Surfactant Composition

The present disclosure further relates to concentrated branched sulfonate surfactant compositions. Such concentrated compositions are useful for saving transportation costs and for incorporation into product compositions at desired levels without bringing in much undesired and/or inactive material, such as carriers.

The concentrated branched sulfonate compositions of the present disclosure may comprise from about 75%, or from about 80%, or from about 85%, or from about 90%, or from about 95% to about 99%, or to about 98%, by weight of the composition, of branched sulfonate surfactant.

The branched sulfonate surfactant may be a branched surfactant of the formula X−Y, wherein X is a hydrophobic branched alkyl moiety, the alkyl moiety comprising: (1) from about 9 to about 18 total carbons, on average, in the moiety; (2) a longest linear carbon chain attached to the Y moiety, the longest linear carbon chain having, from about 8 to about 17 carbon atoms, on average; and (3) one or more, on average, alkyl moieties (“branch moieties”) branching from the longest linear carbon chain, the branch moieties having from about 1 to about 3 carbon atoms, on average; and wherein Y is a sulfonate moiety. Suitable branched sulfonate surfactants are described in more detail above in the section titled “(a) Branched Sulfonated Surfactant.”

The concentrated branched sulfonate surfactant may be substantially in acid form. The pH of the concentrated composition may be from about 1 to about 6, or to about 5, or to about 4, or to about 3, or to about 2. At least a portion of the concentrated branched sulfonate surfactant may be neutralized, preferably with a caustic agent, such as sodium hydroxide. At least a portion of the concentrated branched sulfonate surfactant may be present in salt form, preferably a sodium salt form.

The concentrated branched sulfonate surfactant compositions of the present disclosure may comprise from about 1%, or from about 2%, to about 25%, or to about 20%, or to about 15%, or to about 10%, or to about 5%, or to about 2%, by weight of the composition, of an additional material. The additional material may be selected from water, unsulfonated alcohol (alkoxylated and/or non-alkoxylated), an alkali metal sulfate salt (preferably sodium sulfate) and/or other electrolytes, linear alkyl benzene sulfonate (preferably acid-form), paraffin sulfonic acids, organic solvent, and mixtures thereof. These materials may be processing aids, by-products, and/or unreacted reactants from the synthesis of the branched sulfonate surfactant. Additionally or alternatively, these materials may be the products of hydrolysis of the branched sulfonate surfactant.

The concentrated branched sulfonate surfactant compositions may be substantially free of other surfactants, such as other anionic, nonionic, amphoteric, cationic surfactants, and/or zwitterionic surfactants.

### Method of Making Branched Sulfonated Surfactants

The present disclosure relates to methods of making branched sulfonated surfactants. For example, the method may comprise the steps of providing a branched alcohol may be provided, and then sulfonating the alcohol according to known methods.

The present disclosure encompasses several processes for preparing mid- to near-mid-chain branched alkyl sulfonates in which the sulfonate is attached to a primary carbon atom. These processes require suitable branched materials to be used as the basic feedstock which provides the hydrophobic portion of the branched-chain detersive surfactants. These branched feedstocks may include branched alpha olefins, branched primary alcohols, and branched primary alkyl halides that are known in the industry.

The following three (non-limiting) processes may be suitable as methods of making the branched sulfonate surfactants of the present disclosure. Note—although the following processes are primarily directed to processes for preparing “mid- to near-mid chain branched primary alkyl sulfonate surfactants,” the methods of the present disclosure are not intended to be limited to such surfactants but instead may be applied, as appropriate, to any branched sulfonate surfactant of the present disclosure (e.g., as described in the section titled “(a) Branched Sulfonated Surfactant”).

1. The present disclosure relates to a process for preparing mid- to near-mid chain branched primary alkyl sulfonate surfactants, comprising the steps of:
(a) reacting a 9 to 16 carbon mid-chain or near mid-chain branched alpha olefin with a 2 to 5 carbon terminally unsaturated alkenyl primary halide using a rhuthenium metathesis catalyst; and
(b) hydrogenation with a suitable hydrogenation catalyst to remove unsaturation in the hydrocarbon chain; wherein the hydrogenation catalyst is preferably selected from catalysts comprising nickel, aluminum, platinum, palladium and mixtures thereof; and
(c) sulfonation using sodium, potassium or ammonium sulfite or sodium metabisulfitebisulfite.

The 8 to 16 carbon mid-chain or near mid-chain branched alpha olefin may be made from an 8 to 16 carbon mid-chain or near mid-chain branched primary alcohol.

2. The present disclosure relates to a process for preparing mid- to near-mid chain branched primary alkyl sulfonate surfactants, comprising the steps of:
(a) sulfonating a composition comprising 10 to 18 carbon mid-chain or near mid-chain branched alpha olefins using sodium bisulfite, oleum or sulfur trioxide;
(b) separation of the mid- to near-mid chain branched primary alkyl sulfonate surfactants from other chemical components using distillation, chromatography or molecular sieves or any combination thereof.

3. The present disclosure also relates to a process for preparing mid- to near-mid chain branched primary alkyl sulfonate surfactants, comprising the steps of:
(a) sulfonating a composition comprising 10 to 18 carbon mid-chain or near mid-chain branched alkyl halide using sodium, potassium or ammonium sulfite or sodium metabisulfitebisulfite
(b) separation of the mid- to near-mid chain branched primary alkyl sulfonate surfactants from other chemical components using distillation, chromatography or molecular sieves or any combination thereof.

The 10 to 18 carbon mid-chain or near mid-chain branched alkyl halide may be made from a 10 to 18 carbon mid-chain or near mid-chain branched primary alcohol.

Certain components and steps of suitable processes described herein are discussed in more detail below.

Branched Alpha Olefins

There are many sources of mid-chain or near mid-chain alpha olefins in the C8 to C18 chainlength range that can be used in compositions according to the present disclosure. These include ethylated alpha olefins such as those described by Shell in EP455306 and US5043516.

Also included are the branched alpha olefins that are made from Fischer-Tropsch (F-T chemistry. Synthesis gas (carbon monoxide/hydrogen) can be produced from coal or other hydrocarbon feedstocks such as natural gas and used to build-up various saturated and unsaturated linear, branched and cyclic hydrocarbons using conventional Fischer-Tropsch (F-T) chemistry. Such processes can be used to make a range of hydrocarbons to meet the gasoline, diesel and jet fuel needs. Two points with regard to the present disclosure are: first, recognition that branching occurs in F-T chemistry through free radical, not carbonium ion chemistry. This leads to isolated methyl branches with no gem-dimethyl, little ethyl and low levels of vicinal-dimethyl branches. Low pressure/low temp (i.e. wax producing) F-T chemistry builds up methylenes mostly in a linear fashion with typically about 1 methyl branch per 50 carbons. At higher pressures and/or higher temperatures (such as used for gasoline production) 1 methyl branch per 8 carbon atoms can be achieved. The rearrangement to form the methyl branch, which occurs adjacent to the catalyst, can be thought of as a hydrogen atom shift from the beta methylene to the alpha methylene converting it to the methyl branch. Catalyst (Fe, Co, Ru, etc.) moves from alpha to beta and with insertion of additional methylene(s) between catalyst and the methine group (former beta), isolation of the methyl branch is complete. The second key point is that alpha olefins can be a major product of F-T chemistry.

The present disclosure makes use of such observations to provide an overall method for preparing mid- or near-mid chain branched alpha-olefins which can be converted to the corresponding detersive surfactants, either directly or through the formation of intermediate compounds (e.g., branched-chain alcohols) which are subsequently converted into the sulfonated surfactants. Importantly, the surfactants thus made contain little or no contaminants such as the geminal or vicinal branches or multiple chain branches (i.e., more than about 3 branches). On a weight basis, such contaminants can detract from overall detergency performance and/or biodegradability of the final surfactant products herein.

The Fischer-Tropsch process is described in Kirk-Othmer Encyclopedia of Chemical Technology, 4th Edition, Volume 12, pp. 157-164 (1994), Jacqueline I. Kroschwitz, Executive

Editor, Wiley-Interscience, N. Y. The overall process may be as follows:

1) Synthesis gas, a mixture of carbon monoxide/hydrogen is typically generated from coal or natural gas, however petroleum or other hydrocarbon sources could in principle be utilized. Air or oxygen is used to partially burn gas, petroleum, etc., to a mixture of carbon monoxide and hydrogen. Similarly, coal or coke can undergo the coke-water-gas reaction to form carbon monoxide and H₂. The water gas shift reaction can be used to change the carbon monoxide/hydrogen ratio as required. Various standard cleanup steps are included to remove carbon dioxide, hydrogen sulfide, ammonia etc.
Gas+air or O₂→CO/H₂ mixture
C+H₂O→CO+H₂ coke-water-gas reaction
CO+H₂O→H₂+CO₂ (water gas shift)

2) Fischer-Tropsch (F-T) chemistry is used to convert synthesis gas into a mostly hydrocarbon mixture. Conditions can be set to produce a mostly linear olefin mixture with a limited number of methyl branches as well as some cyclic hydrocarbons. Small amounts of other classes of compounds such as alcohols are also formed. Their levels can be somewhat controlled by F-T conditions; in any event they can be removed.
CO/H₂→Syn Fuel Mixture+Branched Alpha-Olefins

3) Distillation and other standard techniques are used to isolate the desired MW hydrocarbon fraction containing alpha-olefins. Molecular sieving can be used to separate most of the linear alpha-olefins and cyclics from the desired, limited methyl-branched, linear alpha-olefins.

Standard methods utilizing zeolites can accomplish the former. Processing with zeolite sieves can be arranged to remove iso and anteiso (omega-1) and (omega-2) methyl alpha olefins, if so desired. Aliphatic hydrocarbons containing 2 geminal Me groups or highly branched aliphatic hydrocarbons (including cyclics) can be separated from aliphatic hydrocarbons containing Me groups on different C atoms and less branched aliphatic hydrocarbons by selective adsorption of the latter on a molecular sieve (pore diam. 4.4-5.0 A°) and/or from pyrolyzed poly(vinylidene chloride) (Saran) to yield gasoline with improved octane numbers; see Neth Appl. 7111508 Oct. 25, 1971, Chem. Abstracts 76:88253.
Syn Fuel Mixture→Branched alpha-Olefins

A suitable example of branched alpha olefins is produced based on Fischer Tropsch technology from coal by the synthetic fuels experts, Sasol. This technology produces a mixture of non-linear and linear alpha olefins along with other constituents such as paraffins, saturated hydrocarbons, and other materials. These alpha olefins may be used in the described processes to prepare branched alkyl sulfonates either with or without the removal of these other constituents. In the situations where these constituents are not removed prior to chemical reaction with the alpha olefin, they can be removed after the olefin has been converted to an intermediate or the final sulfonated product.

Suitable branched alpha olefins can also be prepared by oligomerization of propylene or butylene. Examples include tri-butylene or tetrapropylene. Co-oligomerization of propylene and butylene can also be used. Suitable procedures have been described by in the work by Mobil in U.S. Pat. No. 4,870,038, U.S. Pat. No. 5,026,933 and U.S. Pat. No. 5,284,989 on selective oligomerization of propylene and butylenes using catalytic zeolitic sieve technology. Co-oligomerization of propylene or butylene or higher alpha-olefins with ethylene can also be prepared as described by Shell in US7037988 and U.S. Pat. No. 7,238,764. In another example, in WO2014209711, Dow Chemical described a process for preparing branched olefins in which the majority of the mid-branched groups are ethyl or higher alkyl, at least 50% of the branches are ethyl or higher alkyl and there is no (<1%) terminal iso type of branching.

An additional source of alpha olefins according to the present disclosure can come from the movement or isomerization of the double bond of a suitable internal olefin or vinylidene olefin into the alpha position. For example, in CA2001537, Slaugh et al. describe a process for producing an olefin product having an enhanced alpha olefin content from an olefin feedstock comprising internal olefins or a mixture of internal and alpha olefins. Their process comprises (a) contacting said olefin feedstock with an anthracene, at a temperature in the range of from 150 to 275° C. to form an olefin adduct with the anthracene, (b) separating said adduct from the product of step (a), (c) heating said separated adduct at a temperature in the range of from 250 to 400° C. to produce anthracene and an olefin product enhanced in alpha olefin content over the alpha olefin content of the feedstock, and (d) separating anthracene from the product of step (c) to produce said product enriched in alpha olefin.

The method described in CA2001537 and other methods for conversion of internal olefins to alpha olefins can be used to convert branched internal olefins into branched alpha olefins suitable for the compositions and methods of the present disclosure. The preparation of suitable branched internal olefins for this purpose are described by skeletal isomerization of alpha or internal olefins by Texaco (U.S. Pat. No. 5,510,560) and Shell (U.S. Pat. No. 6,150,322). Suitable branched internal olefins can also be prepared from paraffinic waxes as described by Shell in U.S. Pat. No. 7,348,462. Dimerized olefins and vinylidene olefins as described by Shell in WO200537750 can also be converted to suitable branched alpha olefins using the isomerization methods such as those described in CA2001537.

Branched Alcohols

Conversion of branched internal and alpha olefins to a primary alcohol composition is conveniently accomplished, for example, by hydroformylation, by oxidation and hydrolysis, by sulfation and hydration, by epoxidations and hydration, or the like. In hydroformylation, the skeletally isomerized olefins are converted to alkanols by reaction with carbon monoxide and hydrogen according to the Oxo process. Most commonly used is the “modified Oxo process”, using a phosphine, phosphite, arsine or pyridine ligand modified cobalt or rhodium catalyst, as described in U.S. Pat. Nos. 3,231,621; 3,239,566; 3,239,569; 3,239,570; 3,239,571; 3,420,898; 3,440,291; 3,448,158; 3,448,157; 3,496,203; and 3,496,204; 3,501,515; and 3,527,818, the disclosures of which are incorporated herein by reference. Methods of production are also described in Kirk Othmer, “Encyclopedia of Chemical Technology” 3rd Ed. vol 16, pages 637-653; “Monohydric Alcohols: Manufacture, Applications and Chemistry”, E. J. Wickson, Ed. Am. Chem. Soc. 1981, incorporated herein by reference.

Branched primary alcohols are suitable for conversion to the branched primary alkyl halides or branched alpha olefins needed in the described processes for preparing branched alkyl sulfonates. Process for producing a-olefins from the dehydration of alcohols, has been described in detail by Knozinger, H., Angew. Chem. (Applied Chemistry), Int. Ed., vol. 7, 1968, no. 10, p. 791-805 and also by Sasol (WO2004078336).

Branched Alkyl Halides

Suitable branched alkyl halides can be produce from the branched alpha olefins or branched primary alcohols described above. For example, US5831137 describes a continuous non-catalytic process for the preparation of alkyl halides from branched olefins and hydrohalic acids.

Metathesis Catalysts

Rhuthenium based catalysts reported in the literature to catalyze cross-metathesis of olefins with vinyl halides (Sashuk et al., Chem. Commun., 2008, 2468-2470) and allyl halides (Chatterjee et al., J. American Chemical Society, 2003, v125, 11360-11370) are incorporated herein by reference.

Unsaturated Alkenyl Halides

This class of materials includes 2 to 5 carbon terminally unsaturated alkenyl halides. Allyl halides and vinyl halides are preferred. Allyl chloride and vinyl chloride are especially preferred.

Sulfonation

Sulfonation of alpha olefins is reported in the literature and incorporated herein by reference. Bright et al., J. appl. Chem. Biotechnol. 1975,25,901-912 and Herke and Rasheed JAOCS, Vol. 69, no. 1, January 1992, demonstrated alkane sulfonate preparation by the free radical addition of sodium bisulphite to linear olefins (sulphitation).

Sulfonation of alpha olefins is accomplished in the Chevron process by first sulfonating the olefins in a continuous thin film reactor with dilute sulfur trioxide to produce a mixture of alkene sulfonic acids and sultones (cyclic sulfonate esters). The mixture is neutralized with aqueous sodium hydroxide, then hydrolyzed at elevated temperatures to convert the remaining sultones to alkene sulfonates and hydroxy sulfonates. This results in an aqueous solution of alpha olefin sulfonate.

Sulfuric acid, oleum, sulfur trioxide, sodium or potassium sulfite, chlorosulfonic acid and sulfamic acid can all be used for sulfonation reactions.

The preparation of alkane sulfonates from alkyl halides has been previously reported by Reed and Tartar in J. Am. Chem. Soc., 1935, 57 (3), pp 570-571 using alkyl chloride, iodide or bromide reacted with anhydrous sodium, potassium or ammonium sulfite.

### Method of Making Detergent Compositions

The present disclosure relates to methods of making detergent compositions comprising the surfactant systems described herein. The method may include combining the components of the compositions described herein in the proportions described.

For example, the process of making a surfactant composition may comprise the steps of:
i) providing surfactants (a) and (b), where (a) is a branched surfactant of the formula:

X−Y

wherein X is a hydrophobic branched alkyl moiety, the alkyl moiety comprising: (1) from about 9 to about 18 total carbons, on average, in the moiety; (2) a longest linear carbon chain attached to the Y moiety, the longest linear carbon chain having from about 8 to about 17 carbon atoms, on average; and (3) one or more alkyl moieties (“branch moieties”) branching from the longest linear carbon chain, the branch moieties having from about 1 to about 3 carbon atoms, on average; and wherein Y is a sulfonate moiety; and where (b) is a non-sulfonated detersive surfactant; and
ii) combining (a) and (b) in a weight ratio of from about 5:95 to about 95:5, or from about 90:10 to about 10:90, or from about 75:25 to about 25:75, or from about 70:30 to about 30:70, or from about 60:40 to about 40:60, or about 50:50.

The non-sulfonated detersive surfactant may be selected from the group consisting of anionic surfactant, nonionic surfactant, amphoteric surfactant, and mixtures thereof.

The process may further comprise the step of combining at least one detergent adjunct with (a) and/or (b) to form the surfactant composition.

Surfactants (a) and (b) may be part of a surfactant system, where the surfactant system is present at a level of from about 5% to about 75%, by weight of the surfactant composition.

Liquid compositions according to the present disclosure may be made according to conventional methods, for example in a batch process or in a continuous loop process.

Dry (e.g., powdered or granular) compositions may be made according to conventional methods, for example by spray-drying or blow-drying a slurry comprising the components described herein.

The detergent compositions described herein may be encapsulated in a pouch, preferably a pouch made of water-soluble film, to form a unit dose article that may be used to treat fabrics.

### Method of Using Detergent Compositions

The present disclosure relates to methods of using the detergent compositions described herein.

For example, the present disclosure relates to a method of treating a fabric, the method comprising the step of contacting a fabric with a detergent composition described herein, preferably in the presence of water. The method may further comprise the step of carrying out a washing or cleaning operation. Water may be added before, during, or after the contacting step to form a wash liquor.

The present disclosure also relates to a process for the washing, for example by machine, of fabric, preferably soiled fabric, using a composition according to the present disclosure, comprising the steps of, placing a detergent composition according to the present disclosure into contact with the fabric to be washed, and carrying out a washing or cleaning operation.

Any suitable washing machine may be used, for example, a top-loading or front-loading automatic washing machine. Those skilled in the art will recognize suitable machines for the relevant wash operation. The article of the present disclosure may be used in combination with other compositions, such as fabric additives, fabric softeners, rinse aids, and the like. Additionally, the detergent compositions of the present disclosure may be used in known hand washing methods.

The present disclosure may also be directed to a method of treating a fabric, the method comprising the steps of contacting a fabric with a detergent composition described herein, carrying out a washing step, and then contacting the fabric with a fabric softening composition. The entire method, or at least the washing step, may be carried out by hand, be machine-assisted, or occur in an automatic washing machine. The step of contacting the fabric with a fabric softening composition may occur in the presence of water, for example during a rinse cycle of an automatic washing machine.

### COMBINATIONS

Specifically contemplated combinations of the disclosure are herein described in the following lettered paragraphs. These combinations are intended to be illustrative in nature and are not intended to be limiting.

A. A surfactant composition comprising: from about 5% to about 75%, by weight of the surfactant composition, of a surfactant system, the surfactant system comprising: (a) a branched surfactant of the formula X−Y, wherein X is a hydrophobic branched saturated alkyl moiety, the alkyl moiety comprising: (1) from about 9 to about 18 total carbons, on average, in the moiety;

(2) a longest linear carbon chain attached to the Y moiety, the longest linear carbon chain having, from about 8 to about 17 carbon atoms, on average; and (3) one or more, on average, alkyl moieties (“branch moieties”) branching from the longest linear carbon chain, the branch moieties having from about 1 to about 3 carbon atoms, on average; and wherein Y is a sulfonate moiety; and (b) a non-sulfonated detersive surfactant; wherein the weight ratio of (a):(b) is from about 5:95 to about 95:5.

B. A surfactant composition according paragraph A, wherein the longest linear carbon chain in the -X moiety has from about 10 to about 17 carbons, preferably from about 12 to about 17 carbons, more preferably from about 14 to about 17 carbons.

C. A surfactant composition according to any of paragraphs A-B, wherein the longest linear carbon chain in the -X moiety has an average number of carbons that is from 12 to 13, from 14 to 15, or from 16 to 17.

D. A surfactant composition according to any of paragraphs A-C, wherein the branch moieties have from about 1 to about 2.5, preferably from about 1 to about 2, more preferably from about 1.5 to about 2, carbons on average.

E. A surfactant composition according to any of paragraphs A-D, wherein a majority of the branch moieties are methyl groups.

F. A surfactant composition according to any of paragraphs A-E, wherein at least one of the branch moieties is attached directly to a carbon of the longest linear carbon chain located at position 2 or greater, wherein the carbon at position 1 is the carbon of the longest linear carbon chain attached to the -Y moiety.

G. A surfactant composition according to any of paragraphs A-F, wherein at least one of the branch moieties is attached directly to a carbon of the longest linear carbon chain located at a position in the range of from position 2, or from position 3, to position (ω−2), wherein the terminal carbon of the longest linear carbon chain is at positon to ω.

H. A surfactant composition according to any of paragraphs A-G, wherein the X- moiety is not substituted with a sulphonate group, preferably is not substituted with a non-alkyl group.

I. A surfactant composition according to any of paragraphs A-H, wherein at least 30% of the branched surfactant includes branching moieties.

J. A surfactant composition according to any of paragraphs A-I, wherein Y is a non-alkoxylated sulfonate moiety.

K. A surfactant composition according to any of paragraphs A-J, wherein the non-sulfonated detersive surfactant is selected from the group consisting of anionic surfactant, nonionic surfactant, amphoteric surfactant, zwitterionic surfactant, and mixtures thereof.

L. A surfactant composition according to any of paragraphs A-K, wherein the non-sulfonated detersive surfactant is an anionic surfactant, preferably an alkyl alkoxylated sulfate surfactant, more preferably an alkyl ethoxylated sulfate surfactant.

M. A surfactant composition according to any of paragraphs A-K, wherein the non-sulfonated detersive surfactant is a nonionic surfactant, preferably an ethoxylated alcohol surfactant.

N. A surfactant composition according to any of paragraphs A-K, wherein the non-sulfonated detersive surfactant is an amphoteric surfactant, preferably an amine oxide surfactant.

O. A surfactant composition according to any of paragraphs A-K, wherein the non-sulfonated detersive surfactant is a cationic surfactant, preferably a quaternary ammonium surfactant.

P. A surfactant composition according to any of paragraphs A-K, wherein the non-sulfonated detersive surfactant is a zwitterionic surfactant, preferably a betaine surfactant.

Q. A surfactant composition according to any of paragraphs A-K, wherein the non-sulfonated detersive surfactant is selected from the group consisting of alkyl alkoxylated sulfate surfactant, ethoxylated alcohol surfactant, amine oxide surfactant, quaternary ammonium surfactant, betaine surfactant, and mixtures thereof.

R. A surfactant composition according to any of paragraphs A-Q, wherein the surfactant system further comprises alkyl benzene sulfonate surfactant, preferably linear alkyl benzene sulfonate surfactant.

S. A surfactant composition according to any of paragraphs A-R, the composition comprising from about 5% to about 50%, preferably from about from about 8% to about 30%, by weight of the surfactant composition, of the surfactant system.

T. A surfactant composition according to any of paragraphs A-T, the composition further comprising at least one detergent adjunct, preferably a detergent adjunct selected from the group consisting of fatty acids and/or salts thereof, enzymes, encapsulated benefit agents, soil release polymers, hueing agents, builders, chelating agents, dye transfer inhibiting agents, dispersants, enzyme stabilizers, catalytic materials, bleaching agents, bleach catalysts, bleach activators, polymeric dispersing agents, soil removal/anti-redeposition agents, polymeric dispersing agents, polymeric grease cleaning agents, brighteners, suds suppressors, dyes, hueing agents, perfume, structure elasticizing agents, fabric softeners, carriers, fillers, hydrotropes, solvents, anti-microbial agents and/or preservatives, neutralizers and/or pH adjusting agents, processing aids, opacifiers, pearlescent agents, pigments, anti-corrosion and/or anti-tarnishing agents, and mixtures thereof.

U. A surfactant composition according to any of paragraphs A-T, wherein the surfactant composition is a hard surface cleaning composition or a fabric care composition.

V. A detergent composition comprising: from about 5% to about 45%, preferably from about 8% to about 30%, by weight of the detergent composition, of a surfactant system, the surfactant system comprising: (a) a branched surfactant of the formula X - Y, wherein X is a hydrophobic branched alkyl moiety, the alkyl moiety comprising: (1) from about 9 to about 18 total carbons, on average, in the moiety; (2) a longest linear carbon chain attached to the Y moiety, the longest linear carbon chain having from about 8 to about 17 carbon atoms, on average; and (3) one or more alkyl moieties (“branch moieties”) branching from the longest linear carbon chain, the branch moieties having from about 1 to about 3 carbon atoms, on average; and wherein Y is a sulfonate moiety; (b) an anionic alkyl alkoxylated sulfate surfactant; wherein the weight ratio of (a):(b) is from about 30:70 to about 70:30; and a detergent adjunct.

X. A detergent composition according to paragraph W, wherein the surfactant system further comprises nonionic surfactant.

Y. A process of treating a fabric, the process comprising the step of contacting a fabric with the composition according to any of paragraphs A-X, preferably in the presence of water.

Z. A process of making a surfactant composition, the process comprising the steps of: providing surfactants (a) and (b) as listed below, where (a) is a branched surfactant of the formula X - Y, wherein X is a hydrophobic branched alkyl moiety, the alkyl moiety comprising: (1) from about 9 to about 18 total carbons, on average, in the moiety; (2) a longest linear carbon chain attached to the Y moiety, the longest linear carbon chain having from about 8 to about 17 carbon atoms, on average; and (3) one or more alkyl moieties (“branch moieties”) branching from the longest linear carbon chain, the branch moieties having from about 1 to about 3 carbon atoms, on average; and wherein Y is a sulfonate moiety; and where (b) is a non-sulfonated detersive surfactant; and combining (a) and (b) in a weight ratio of from about 5:95 to about 95:5, or from about 90:10 to about 10:90, or from about 75:25 to about 25:75, or from about 70:30 to about 30:70, or from about 60:40 to about 40:60, or about 50:50.

AA. A process of making a surfactant composition according to paragraph Z, wherein the non-sulfonated detersive surfactant is selected from the group consisting of anionic surfactant, nonionic surfactant, amphoteric surfactant, and mixtures thereof.

AB. A process of making a surfactant composition according to any of paragraphs Z-AA, the process further comprising the step of combining at least one detergent adjunct with (a) and/or (b) to form the surfactant composition.

AC. A process of making a surfactant composition according to any of paragraphs Z-AB, wherein (a) and (b) are part of a surfactant system, where the surfactant system is present at a level of from about 5% to about 75%, by weight of the surfactant composition.

AD. A concentrated branched sulfonate surfactant composition comprising from about 75% to about 99%, by weight of the composition, of a branched sulfonate surfactant of the formula: X−Y, wherein X is a hydrophobic branched saturated alkyl moiety, the alkyl moiety comprising: (1) from about 9 to about 18 total carbons, on average, in the moiety; (2) a longest linear carbon chain attached to the Y moiety, the longest linear carbon chain having, from about 8 to about 17 carbon atoms, on average; and (3) one or more, on average, alkyl moieties (“branch moieties”) branching from the longest linear carbon chain, the branch moieties having from about 1 to about 3 carbon atoms, on average; and wherein Y is a sulfonate moiety.

AE. A concentrated branched sulfonate surfactant composition according to paragraph AD, wherein the branched sulfonate surfactant is substantially in acid form.

AF. A concentrated branched sulfonate surfactant composition according to any of paragraphs AD-AE, wherein the composition further comprises an additional material selected from water, unsulfonated alcohol, an alkali metal sulfate salt, linear alkyl benzene sulfonate, paraffin sulfonic acid, organic solvent, and mixtures thereof.

### TEST METHODS

### Dynamic Interfacial Tension (DIFT) Analysis

Dynamic Interfacial Tension analysis is performed on a Krüss® DVT30 Drop Volume Tensiometer (Krüss USA, Charlotte, N.C.). The instrument is configured to measure the interfacial tension of an ascending oil drop in aqueous surfactant (surfactant) phase. The oil used is canola oil (Crisco Pure Canola Oil manufactured by The J.M. Smucker Company). The aqueous surfactant and oil phases are temperature controlled at 22° C. (+/−1 ° C.), via a recirculating water temperature controller attached to the tensiometer. A dynamic interfacial tension curve is generated by dispensing the oil drops into the aqueous surfactant phase from an ascending capillary with an internal diameter of 0.2540 mm, over a range of flow rates and measuring the interfacial tension at each flow rate. Data is generated at oil dispensing flow rates of 500 uL/min to 1 uL/min with 2 flow rates per decade on a logarithmic scale (7 flow rates measured in this instance). Interfacial tension is measured on three oil drops per flow rate and then averaged. Interfacial tension is reported in units of mN/m. Surface age of the oil drops at each flow rate is also recorded and plots may be generated either of interfacial tension (y-axis) versus oil flow rate (x-axis) or interfacial tension (y-axis) versus oil drop surface age (x-axis) Minimum interfacial tension (mN/m) is the lowest interfacial tension at the slowest flow rate, with lower numbers indicating improved performance Based on instrument reproducibility, differences greater than 0.1 mN/m are significant for interfacial tension values of less than 1 mM/m.

### EXAMPLES

The examples provided below are intended to be illustrative in nature and are not intended to be limiting. Ingredients are provided as weight percent of the composition, unless indicated otherwise.

### Synthesis Example 1

### Synthesis of Branched C12/13 Alkyl Chloride from C23 Alcohol

A 2 L 3 neck 24/40 RBF is equipped w a thermometer in side neck, reflux condenser in center neck and an addition funnel in side neck. The system is equipped with positive nitrogen pressure inlet at top of addition funnel and outlet at the top of condenser. The gas effluent is run through a 1 L trap which is connected to a caustic bath/acid scrubber which is externally cooled.

The flask is charged with anhydrous DMF (100 ml) and the contents cooled to 0-10C. To this is added thionyl chloride (357 g, 3 moles) followed by Safol-23 Alcohol (485 g, 2.5 moles) at rate to maintain temperature at 0-10 C. Gas evolution is noted during the last ˜⅓ of alcohol addition. The reaction temperature is slowly increased. At 50-60 C gas evolution is noted. The temperature is maintained at 50-60 C until no further gas is evolved (˜1hr). The temperature is slowly increased until gentle gas evolution is noted at 115-120 C. This temp is maintained for 5 hrs. The reaction is cooled to ambient temperature. 200 ml H₂O is added to the crude reaction over 5 min with rapid stirring. The aqueous phase is separated from the organic. The organic phase is washed with 200 ml saturated aqueous sodium bicarbonate followed by 200 ml 10% aqueous sodium chloride. 452 grams of crude brown organic phase resulted.

The crude product is distilled through a short path set-up yielding 450 grams of light yellow product oil at 91-94 C & 0.50 Torr. The H and C13-NMR's conformed to product.

### Synthesis Example 2

### Synthesis of Branched C16/17 Alkyl Chloride from N67 Alcohol

The procedure in Synthesis Example 1 is followed using anhydrous DMF (75m1), thionyl chloride (238g, 2.0 moles), N67 Alcohol (427 g, 1.7 moles). The final reaction temperature of 130-135 is maintained for 7 hrs. Distillation yielded 330 grams light yellow product oil at 118-125C & 0.3 Torr. The H and C13-NMR's conformed to product.

### Synthesis Example 3

### Synthesis of Branched C12/13-Sodium Sulfonate from Branched C12/13 Alkyl Chloride

A 1 gallon Parr reactor is charged with branched C12/13 alkyl chloride (450 g, 2.13 moles) from Synthesis Example 1, anhydrous sodium sulfite (338 g, 2.65 moles) & water (2 L). The reactor is sealed, purged 3×150 PSI nitrogen, charged 100 PSI nitrogen and the contents heated to 180 C for 10hrs with maximum stirring (˜650 RPM). The reactor is cooled and the crude product removed. The crude product is stripped of water.

H-NMR analysis of the crude product showed the organic portion to be a mixture of ˜35:65 Safol-23 Alcohol:Na Sulfonate. The crude product is ground and the alcohol is extracted by refluxing in 2L acetone 1 hr, filtering out the crude product and rinsing 2×500 ml fresh acetone.

This extraction procedure is repeated 2 additional times.

The product is extracted from the crude filter cake using a soxhlet extractor with ethanol for 20 hrs. Stripping and drying of the ethanol extract yielded 395 g white product powder. The H and C13-NMR's conformed to product. The product is determined to be 87.6% active by CAT SO3 titration.

### Synthesis Example 4

### Synthesis of Branched C16/7-Sodium Sulfonate from Branched C16/17 Alkyl Chloride

The procedure in Synthesis Example 3 is followed using branched C16/17 alkyl chloride (300 g, 1.2 moles) from Synthesis Example 2, anhydrous sodium sulfite (189 g, 1.5 moles) & water (1.2 L) yielding 141 grams of white product powder. The H and C13-NMR's conformed to product. The product is determined to be 85.3% active by CAT SO3 titration.

### Synthesis Example 5

### Synthesis of Branched C12 Sodium Sulfonate from Branched C12 Alpha Olefin

Deoxygenated, deionised water (300 ml), isopropanol (400 ml), mid chain branched C12 alpha olefin (52.1 g, 0.31 mol) and t-butyl perbenzoate (1 g, 0.005 mol) are placed in a 1 litre alkyd flask fitted for reflux and equipped with a hook stirrer, thermometer, and a calibrated high temperature glass pH probe (Radiometer model G202CH), which is connected to a pH meter (Radiometer pH M28)-titrator (Radiometer TTT 11) assembly. An addition tube which protrudes into the flask is connected via a titrator controlled magnetic valve (Radiometer MNVI) to an addition funnel for the bisulphite solution. The whole system is protected from atmospheric oxygen by use of a static nitrogen atmosphere. After the contents of the flask are heated to reflux with stirring an aqueous solution containing 0.36 g ion sodium in a sodium bisulphite to sodium sulphite mole ratio of 7:2 is added to the mixture in sufficient quantity to obtain the desired pH of 7.3. The tendency of the pH to rise during the reaction is countered by addition of more of the bisulphite/sulphite solution until it has all been added. Subsequent control of pH is then effected by addition of sulphur dioxide gas until the reaction system can no longer sustain a pH of 7.3. The reaction is then complete. After the reaction mixture has been allowed to cool unchanged olefin is extracted with light petroleum ether (40-60′). The residual aqueous isopropanol layer containing the product is evaporated to give a white solid which is dried in a vacuum oven at 80 C. The reaction product comprises 85% by weight sodium branched dodecyl-1-sulfonate and 15% by weight disodium branched dodecyl-2-sulphinate-1-sulphonate 15 w/w.

### Example 1

### Branched Sulfonate Surfactant and AES

To demonstrate the benefits of surfactant systems including the branched alkyl sulfonates of the present disclosure vs. reference surfactant systems, Dynamic Oil-water Interfacial Tension (DIFT) analysis is performed. Samples having surfactant systems as shown in Table 1 are prepared as follows.

Samples containing a total at 200 ppm surfactant in water with a hardness (3:1 Ca:Mg) of 7 grains per gallon (gpg) and at pH 8.2-8.5 at 22° C. are prepared with compositions specified in the table below. Each sample is analyzed as described above. Density settings for 22° C. are set at 0.917 g/ml for Canola Oil and 0.998 g/ml for aqueous surfactant phase. The density of the aqueous surfactant phase is assumed to be the same as water since it is a dilute solution. 1.50 mL of 1 (wt/wt) surfactant solution in deionized water is added to a 100 ml volumetric flask to which 3.5 mL of deionized water is added and the volumetric flask is then filled to the mark with a hardness solution of 7.37 gpg water, (3:1 CaCl2:MgCl2 solution) and mixed well.

The solution is transferred to a beaker and the pH is adjusted to 8.2-8.5 by adding a few drops of 0.1N NaOH or 0.1N H₂SO4. The solution is then loaded into the tensiometer measurement cell and analyzed. The total time from mixing the surfactant solution with the hardness solution to the start of analysis is five minutes.

The surfactant systems and DIFT values for each sample are shown below in Table 1. Each group (A-F) of the data set includes surfactants in a different ratio. Percentages are provided by combined weight of the listed surfactants in the sample (i.e., by weight of the surfactant system). Based on instrument reproducibility, Min IFT differences greater than 0.1 mN/m are significant for interfacial tension values of less than 1 mN/m. For higher values of Min IFT, differences are 10% are greater than are significant. Typically, surfactant systems characterized by lower Min IFT values correlate with superior grease cleaning performance.

TABLE 1

| | | | | | | | Min IFT |
|---|---|---|---|---|---|---|---|
| | | Sam- | % N67- | % N67- | % | % | (mN/m), |
| Group | Ratio | ple | Sulfate^{a} | Sulfonate^{b} | LAS^{c} | AES^{d} | 1 uL/min |
| A | 100:0 | 1 | 100 | 0 | 0 | 0 | 0.360 |
| | | 2 | 0 | 100 | 0 | 0 | 0.981 |
| | | 3 | 0 | 0 | 100 | 0 | 1.065 |
| | | 4 | 0 | 0 | 0 | 100 | 2.010 |
| B | 90:10 | 5 | 90 | 0 | 0 | 10 | 0.270 |
| | | 6 | 0 | 90 | 0 | 10 | 0.708 |
| | | 7 | 0 | 0 | 90 | 10 | 0.759 |
| C | 70:30 | 8 | 70 | 0 | 0 | 30 | 0.340 |
| | | 9 | 0 | 70 | 0 | 30 | 0.333 |
| | | 10 | 0 | 0 | 70 | 30 | 0.478 |
| D | 50:50 | 11 | 50 | 0 | 0 | 50 | 0.361 |
| | | 12 | 0 | 50 | 0 | 50 | 0.289 |
| | | 13 | 0 | 0 | 50 | 50 | 0.495 |
| E | 30:70 | 14 | 30 | 0 | 0 | 70 | 0.629 |
| | | 15 | 0 | 30 | 0 | 70 | 0.583 |
| | | 16 | 0 | 0 | 30 | 70 | 0.832 |
| F | 10:90 | 17 | 10 | 0 | 0 | 90 | 1.265 |
| | | 18 | 0 | 10 | 0 | 90 | 1.481 |
| | | 19 | 0 | 0 | 10 | 90 | 1.497 |

^{a}N67-Sulfate is mid-branched alkyl sulfate as disclosed in U.S. Pat. No. 6,020,303 and U.S. Pat. No. 6,060,443. N67 alcohol is obtained from Shell Chemicals, Houston, TX, USA.
^{b}According to Synthesis Example 4
^{c}LAS is linear alkylbenzenesulfonate having an average aliphatic carbon chain length C₁₁-C₁₂ supplied by Stepan, Northfield, Illinois, USA.
^{d}AES is C₁₂₋₁₅ alkyl ethoxy (1.8) sulfate, supplied by Shell Chemicals, Houston, TX, USA.

The results provided in Table 1 show that surfactant systems that include N67-Sulfonate in combination with AES in ratios from 90:10 to 10:90 are characterized by a lower minimum interfacial tension compared to similar surfactant systems that include LAS and AES. The results in Table 1 also show that surfactant systems that include N67-Sulfonate in combination with AES at particular ratios (70:30 to 30:70) are characterized by a lower minimum interfacial tension compared to similar surfactant systems that include N67-Sulfate and AES.

### Example 2

### Branched Sulfonate Surfactant and Nonionic Surfactant

Samples having surfactant systems shown in Table 2 are prepared and analyzed as described in Example 1. The surfactant systems and DIFT values for each sample are shown below in Table 2. Each group (G-J) of the data set includes surfactants in a different ratio.

Percentages are provided by combined weight of the listed surfactants in the sample. Based on instrument reproducibility, Min IFT differences greater than 0.1 mN/m are significant for interfacial tension values of less than 1 mN/m. Typically, surfactant systems characterized by lower Min IFT values correlate with superior grease cleaning performance Note that Samples 20 and 21 are the same as Samples 1 and 2 in Table 1.

TABLE 2

| | | | | | | Min IFT |
|---|---|---|---|---|---|---|
| | | Sam- | % N67- | % N67- | % Nonionic | (mN/m), |
| Group | Ratio | ple | Sulfate^{a} | Sulfonate^{b} | (NI 24-7^{e}) | 1 uL/min |
| G | 100:0 | 20 | 100 | 0 | 0 | 0.360 |
| | | 21 | 0 | 100 | 0 | 0.981 |
| | | 22 | 0 | 0 | 100 | 7.915 |
| H | 70:30 | 23 | 70 | 0 | 30 | 0.806 |
| | | 24 | 0 | 70 | 30 | 0.528 |
| I | 50:50 | 25 | 50 | 0 | 50 | 1.213 |
| | | 26 | 0 | 50 | 50 | 0.740 |
| J | 30:70 | 27 | 30 | 0 | 70 | 1.598 |
| | | 28 | 0 | 30 | 70 | 1.481 |

^{a}N67-Sulfate is mid-branched alkyl sulfate as disclosed in U.S. Pat. No. 6,020,303 and U.S. Pat. No. 6,060,443. N67 alcohol is obtained from Shell Chemicals, Houston, TX, USA.
^{b}According to Synthesis Example 4
^{e}NI 24-7 is C₁₂₋₁₄ with an average degree of ethoxylation of 7 supplied by Huntsman, Salt Lake City, Utah, USA

The results provided in Table 2 show that surfactant systems that include N67-Sulfonate and nonionic surfactant (NI 24-7) in ratios from 70:30 to 30:70 are characterized by a lower minimum interfacial tension compared to similar surfactant systems that include N67-Sulfate and nonionic surfactant.

### Example 3

### Branched Sulfonate Surfactant, Amphoteric Surfactant, and Cationic Surfactant

Samples containing a total at 200 ppm surfactant in water with a hardness (3:1 Ca:Mg) of 3 grains per gallon (gpg) and at pH 8.2-8.5 at 22° C. are prepared with compositions specified in Table 3 below. Each sample is analyzed as described above. Density settings for 22° C. are set at 0.917 g/ml for Canola Oil and 0.998 g/ml for aqueous surfactant phase. The density of the aqueous surfactant phase is assumed to be the same as water since it is a dilute solution. 1.50 mL of 1 (wt/wt) surfactant solution in deionized water is added to a 100 ml volumetric flask to which 3.5 mL of deionized water is added and the volumetric flask is then filled to the mark with a hardness solution of 3.16 gpg water, (3:1 CaCl2:MgCl2 solution) and mixed well. The solution is transferred to a beaker and the pH is adjusted to 8.2-8.5 by adding a few drops of 0.1N NaOH or 0.1N H2504. The solution is then loaded into the tensiometer measurement cell and analyzed. The total time from mixing the surfactant solution with the hardness solution to the start of analysis is five minutes.

TABLE 3

| | | | | | % C₁₂₋₁₄ | % Lauryl | |
|---|---|---|---|---|---|---|---|
| | | | % N67- | | dimethyl | Trimethyl | |
| | | | Sulfate^{a} | % N67- | Amine | Ammonium | Min IFT |
| Group | Ratio | Sample | (comp.) | Sulfonate^{b} | Oxide^{f} | Chloride^{g} | (mN/m), 1 uL/min |
| K | 100:0 | 29 | 100 | 0 | 0 | 0 | 0.218 |
| | | 30 | 0 | 100 | 0 | 0 | 0.778 |
| | | 31 | 0 | 0 | 100 | 0 | 1.225 |
| | | 32 | 0 | 0 | 0 | 100 | 11.655 |
| L | 75:25 | 33 | 75 | 0 | 25 | 0 | 1.450 |
| | | 34 | 0 | 75 | 25 | 0 | 0.886 |
| | | 35 | 75 | 0 | 0 | 25 | 2.558 |
| | | 36 | 0 | 75 | 0 | 25 | 1.243 |

^{a}N67-Sulfate is mid-branched alkyl sulfate as disclosed in U.S. Pat. No. 6,020,303 and U.S. Pat. No. 6,060,443. N67 alcohol is obtained from Shell Chemicals, Houston, TX, USA.
^{b}According to Synthesis Example 4.
^{f}C₁₂₋₁₄ dimethyl Amine Oxide is supplied by Procter & Gamble Chemicals, Cincinnati, USA
^{g}Lauryl Trimethyl Ammonium Chloride is supplied by Evonik, Essen, Germany

The results show that in combination with an amphoteric surfactant, such as C₁₂₋₁₄ dimethyl amine oxide, or a cationic surfactant, such as Lauryl Trimethyl Ammonium Chloride, compositions comprising N67-Sulfonate have a lower minimum interfacial tension than compositions having N67-Sulfate.

### Example 4

### Chemical Stability of Branched Sulfonates

To demonstrate the chemical stability of the benefits of the branched alkyl sulfonates of the present disclosure vs. reference surfactants, a chemical stability test is performed. In this test, a 25% active surfactant concentrates of C23 branched sulfate and C23 branched sulfonate, each derived from Safol 23 alcohol (ex Sasol) are created. The pH of the 25% surfactant concentrates are both adjusted to pH 8 using citric acid. The samples are divided in two and one portion of each sample is stored in an oven at 80° C. for 48 hours. Both samples are visually clear and isotropic at 80° C., indicating that they are in the micellar phase. Dynamic Oil-water Interfacial Tension (DIFT) analysis is performed on all four samples.

Samples containing a total at 400 ppm surfactant in water with a hardness (3:1 Ca:Mg) of 7 grains per gallon (gpg) and at pH 8.2-8.5 at 22° C. are prepared with compositions specified in the table below. Each sample is analyzed as described above. Density settings for 22° C. are set at 0.917 g/ml for Canola Oil and 0.998 g/ml for aqueous surfactant phase. The density of the aqueous surfactant phase is assumed to be the same as water since it is a dilute solution. 1.50 mL of 1 (wt/wt) surfactant solution in deionized water is added to a 100 ml volumetric flask to which 3.5 mL of deionized water is added and the volumetric flask is then filled to the mark with a hardness solution of 3.16 gpg water (3:1 CaCl2:MgCl2 solution) and mixed well. The solution is transferred to a beaker and the pH is adjusted to 8.2-8.5 by adding a few drops of 0.1N NaOH or 0.1N H₂SO4. The solution is then loaded into the tensiometer measurement cell and analyzed. The total time from mixing the surfactant solution with the hardness solution to the start of analysis is approximately five minutes. The Min IFT value obtained at this time is the “fresh” measurement. Samples are then stored for forty-eight hours at 80° C. to simulate long-term and/or stressed storage conditions, and Min IFT is measured again. Results are shown below in Table 4.

Based on instrument reproducibility, Min IFT differences greater than 0.1 mN/m are significant for interfacial tension values of less than 1 mN/m. For higher values of Min IFT, differences are 10% are greater than are significant. Typically, surfactant systems characterized by lower Min IFT values correlate with superior grease cleaning performance.

TABLE 4

| | | Min IFT |
|---|---|---|
| | Surfactant | (mN/m), |
| Sample | (25 wt % active) | 1 uL/min |
| 37 | Branched C23 sulfate^{h} (fresh) | 2.978 |
| (comp.) | | |
| 38 | Branched C23 sulfate^{h} (after 48 hrs at 80° C.) | 12.216 |
| (comp.) | | |
| 39 | Branched C23 sulfonateⁱ (fresh) | 8.038 |
| 40 | Branched C23 sulfonateⁱ (after 48 hrs at 80° C.) | 8.589 |

^{h}Branched sulfate derived from Safol 23 alcohol, obtained from Sasol North America Houston, TX, USA
ⁱAccording to Synthesis Example 3

The results in Table 4 show that the Min IFT of the Branched C23 Sulfate significantly increases after heating while the Min IFT of the Branched C23 Sulfonate does not change as significantly by comparison. Without being bound by theory, it is believed that the Branched C23 Sulfate is less chemically stable upon heating and is more susceptible to hydrolysis than the Branched C23 Sulfonate. This indicates that product compositions formulated with branched sulfonates according to the present disclosure are likely to be more stable and maintain a more consistent performance profile and/or stability upon transport/storage over time compared to comparable formulations that include branched sulfates. It is expected that this stability difference will hold true at higher surfactant concentrations as well (e.g, in concentrated compositions comprising approx. 95wt% branched sulfonate surfactant).

### Example 5

### Heavy Duty Liquid Laundry Detergent Compositions

Heavy duty liquid laundry detergent compositions are made by mixing together the ingredients listed in the proportions shown in Table 5.

TABLE 5

| Raw Material | A | B | C | D | E | F | G | H | I | J | K | L |
|---|---|---|---|---|---|---|---|---|---|---|---|---|
| Branched Sulfonate | 6.9 | 6.7 | 1.9 | 2.6 | 16.9 | 4.8 | 7.6 | 3.4 | 1.2 | 4.4 | 7.9 | 3.5 |
| AES | 11.2 | 14.6 | 7.7 | 4.8 | 13.3 | 7.2 | 1.4 | 7.4 | 7.4 | 14.6 | 4.8 | 7.0 |
| LAS | 0.0 | 2.2 | 0.0 | 7.9 | 0.0 | 4.8 | 2.5 | 1.1 | 3.7 | 4.4 | 2.6 | 3.5 |
| AE | 0.0 | 0.0 | 0.0 | 4.8 | 8.7 | 4.7 | 6.1 | 0.2 | 0.7 | 3.7 | 4.8 | 7.0 |
| C₁₂₋₁₄ dimethyl Amine | 0.7 | 2.0 | 0.6 | 0.5 | 1.2 | 0.0 | 0.5 | 0.0 | 0.5 | 0.9 | 0.0 | 0.0 |
| Oxide | | | | | | | | | | | | |
| Lauryl Trimethyl | 0 | 0 | 0 | 0.25 | 0 | 0.5 | 0 | 1 | 0 | 0 | 0 | 0 |
| Ammonium Chloride | | | | | | | | | | | | |
| Sodium formate | 2 | 0.09 | 1.2 | 0 | 1.6 | 0 | 0.2 | 1.6 | 0.09 | 1.2 | 0 | 1.6 |
| Calcium formate | 0 | 0 | 0 | 0.04 | 0 | 0.2 | 0 | 0.1 | 0 | 0 | 0.04 | 0 |
| Calcium Chloride | 0.01 | 0.08 | 0 | 0 | 0 | 0 | 0.001 | 0.01 | 0.08 | 0 | 0 | 0 |
| Monoethanolamine | 1.4 | 1 | 4 | 0.5 | 0 | To | 2 | 1.4 | 1 | 2.6 | 0.5 | 0.5 |
| | | | | | | pH | | | | | | |
| | | | | | | 8.2 | | | | | | |
| Diethylene glycol | 5.5 | 0 | 4.1 | 0 | 0.7 | 0 | 0 | 3 | 0 | 2 | 0 | 0 |
| Chelant | 0.15 | 0.15 | 0.11 | 0 | 0.5 | 0.11 | 0.8 | 0.15 | 0.15 | 0.11 | 0.07 | 0.15 |
| Citric Acid | 2.5 | 3.96 | 1.88 | 1.98 | 0.9 | 2.5 | 0.6 | 2.5 | 4 | 0 | 1.98 | 1.7 |
| Fatty Acid | 0.8 | 3.5 | 0.6 | 0.99 | 1.2 | 0 | 15 | 0.76 | 2.6 | 2.6 | 0.7 | 0.7 |
| Borax | 1.43 | 2.1 | 2 | 0.75 | 0 | 1.07 | 0 | 1.43 | 2.1 | 1.1 | 0.75 | 2.1 |
| Ethanol | 1.54 | 2 | 1.15 | 0.89 | 0 | 3 | 7 | 1.54 | 2 | 1.15 | 0.89 | 2 |
| Ethoxylated | 0 | 1.4 | 0 | 3 | 0 | 0 | 0.8 | 0 | 2 | 0 | 0 | 1 |
| Polyethylenimine | | | | | | | | | | | | |
| Zwitterionic | 2.1 | 0 | 0.7 | 1.6 | 0.3 | 1.6 | 0 | 0.6 | 0.6 | 0 | 0.6 | 0 |
| ethoxylated | | | | | | | | | | | | |
| quaternized sulfated | | | | | | | | | | | | |
| hexamethylene | | | | | | | | | | | | |
| diamine | | | | | | | | | | | | |
| PEG-PVAc Polymer | 0.1 | 0.2 | 0 | 4 | 0.05 | 0 | 1 | 1.1 | 1.1 | 1.1 | 2.2 | 0 |
| Grease Cleaning | 1 | 2 | 0 | 0 | 1.5 | 0 | 0 | 0 | 4 | 0 | 0 | 1 |
| Alkoxylated | | | | | | | | | | | | |
| Polyalkylenimine | | | | | | | | | | | | |
| Polymer | | | | | | | | | | | | |
| Soil Release Agent | 0 | 0 | 1 | 2 | 0 | 1.5 | 0 | 0 | 0.5 | 0 | 0 | 1 |
| 1,2-Propanediol | 0 | 2.6 | 0 | 3.3 | 0.5 | 2 | 8 | 0 | 6.6 | 0 | 3.3 | 4 |
| Sodium Cumene | 0 | 0 | 0.5 | 1 | 5 | 0 | 0 | 2 | 0 | 0.5 | 1 | 0 |
| sulphonate | | | | | | | | | | | | |
| Fluorescent | 0.2 | 0.1 | 0.05 | 0.3 | 0.15 | 0.3 | 0.2 | 0.2 | 0.1 | 0 | 0.3 | 0.02 |
| Brightener | | | | | | | | | | | | |
| Hydrogenated castor | 0.1 | 0 | 0.4 | 0 | 0 | 0 | 0.1 | 0.1 | 0 | 0.4 | 0 | 0 |
| oil derivative | | | | | | | | | | | | |
| structurant | | | | | | | | | | | | |
| Perfume | 1.6 | 1.1 | 1 | 0.1 | 0.9 | 1.5 | 1.6 | 1.6 | 1.1 | 1 | 0.1 | 0.1 |
| Core Shell Melamine- | 0.5 | 0.05 | 0 | 0.02 | 0.1 | 0.05 | 0.1 | 0.5 | 0.05 | 0 | 0.02 | 0 |
| formaldehyde | | | | | | | | | | | | |
| encapsulate of | | | | | | | | | | | | |
| perfume | | | | | | | | | | | | |
| Protease (40.6 mg | 0.8 | 0.6 | 0 | 0.9 | 0.7 | 0.2 | 1.5 | 0.01 | 0.6 | 0.7 | 0.9 | 0.9 |
| active/g) | | | | | | | | | | | | |
| Mannanase: (25 mg | 0.07 | 0.05 | 0 | 0.06 | 0.04 | 0.001 | 0.1 | 0.07 | 0.05 | 0 | 0.06 | 0.07 |
| active/g) | | | | | | | | | | | | |
| Amylase: (15 mg | 0.3 | 0 | 0.3 | 0.1 | 0 | 0.6 | 0.01 | 0.3 | 0 | 0.3 | 0.1 | 0.3 |
| active/g) | | | | | | | | | | | | |
| Xyloglucanase (20 mg | 0.2 | 0.1 | 0 | 0 | 0.05 | 0.01 | 0.2 | 0.2 | 0.1 | 0 | 0 | 0 |
| active/g) | | | | | | | | | | | | |
| Lipase: (18 mg | 0.4 | 0.2 | 0.3 | 0.1 | 0.2 | 0 | 0 | 0.4 | 0.001 | 0.3 | 0.1 | 0 |
| active/g) | | | | | | | | | | | | |
| Suds Suppressor | 0.21 | 0 | 0.21 | 0 | 0 | 0 | 0 | 0.21 | 0 | 0.21 | 0 | 0.1 |
| Hueing Agent | 0 | 0 | 0 | 0 | 0.05 | 0 | 0 | 1 | 0 | 0 | 0 | 0.001 |

| | |
|---|---|
| *Water, dyes & | Balance |
| minors | |

14652M 49

### Example 6

### Compact/Unit Dose Compositions

Compact or unit dose laundry detergent formulations are made by mixing together the ingredients listed in the proportions shown in Table 6. The formulations may be encapsulated in a water-soluble film, such as M8630 (ex MonoSol LLC) to form a unit dose article. Such unit dose articles can comprise one or multiple compartments.

TABLE 6

| Raw Material | M | N | O | P | Q | R |
|---|---|---|---|---|---|---|
| Branched Sulfonate | 18.0 | 24.0 | 5.0 | 4.0 | 6.0 | 12.0 |
| AE | 14.0 | 2.0 | 14.0 | 2.0 | 1.0 | 2.0 |
| LAS | 0.0 | 0.0 | 14.0 | 14.5 | 17.0 | 12.0 |
| AES | 9.0 | 15.0 | 8.0 | 7.5 | 16.0 | 14.0 |
| Citric Acid | 2.0 | 0.6 | 1.6 | 1.6 | 0.6 | 0.6 |
| Fatty Acid | 4.0 | 10.0 | 4.5 | 16.0 | 4.5 | 4.5 |
| Enzymes | 1.0 | 0.5 | 0.8 | 0.01 | 2.0 | 1.5 |
| Ethoxylated | 1.4 | 1.4 | 4.0 | 7.0 | 4.0 | 4.0 |
| Polyethylenimine | | | | | | |
| Chelant | 0.6 | 0.3 | 2.0 | 1.2 | 3.0 | 3.0 |
| PEG-PVAc Polymer | 4.0 | 2.5 | 1.0 | 2.5 | 1.5 | 1.5 |
| Fluorescent Brightener | 0.2 | 0.4 | 0.3 | 0.3 | 0.1 | 0.3 |
| 1,2 propanediol | 10.0 | 15.0 | 18.0 | 14.8 | 13.0 | 13.8 |
| Glycerol | 13.0 | 4.0 | 6.1 | 6.1 | 6.1 | 6.1 |
| Monoethanolamine | 9.8 | 10.0 | 6.7 | 8.0 | 9.8 | 9.8 |
| TIPA | — | — | 2.0 | — | — | — |
| Sodium Cumene | — | — | — | — | 2.0 | 2.0 |
| sulphonate | | | | | | |
| Cyclohexyl dimethanol | — | — | — | 2.0 | — | — |
| Water | 12.0 | 10.0 | 9.0 | 10.0 | 10.0 | 10.0 |
| Structurant | 0.1 | 0.14 | 0.14 | 0 | 0.2 | 0.14 |
| Perfume | 0.2 | 1.9 | 1 | 1.9 | 1.9 | 1.9 |
| Hueing Agent | 0 | 0.1 | 0.001 | 0.0001 | 0 | 0 |

| | |
|---|---|
| Buffers | To pH 8.0 |
| (monoethanolamine) | |
| Solvents (1,2 | To 100% |
| propanediol, ethanol) | |

All enzyme levels are expressed as % enzyme raw material.

### Example 7

### Granular Laundry Detergent Compositions

Granular laundry detergent compositions are made by mixing together the ingredients listed in the proportions shown in Table 7.

TABLE 7

| Ingredient | S | T | U | V | W | X | Y | Z | AA | AB | AC | AD | AE |
|---|---|---|---|---|---|---|---|---|---|---|---|---|---|
| Branched Sulfonate | 2 | 2 | 0.5 | 20 | 5 | 9 | 1 | 7.1 | 0.5 | 10 | 7.5 | 2 | 5 |
| LAS | 24 | 6 | 20 | 0 | 15 | 2 | 8 | 7.1 | 5 | 1 | 0 | 7.5 | 2 |
| AES | 1.5 | 1 | 0.9 | 0 | 3 | 0.9 | 0 | 4.8 | 1 | 5 | 4 | 4 | 0 |
| AS | 0 | 1 | 2 | 0 | 1 | 0 | 1 | 0 | 1 | 0 | 0 | 0 | 0 |
| AE | 0.5 | 0 | 0 | 2 | 1 | 4 | 2.2 | 0 | 2.2 | 0 | 1 | 0.5 | 6.5 |
| C₁₀₋₁₂ Dimethyl- | | | | | | | | | | | | | |
| hydroxyethylammonium | 0 | 0 | 0 | 0 | 0 | 0 | 0.5 | 1 | 4 | 1 | 0 | 0 | 0 |
| chloride | | | | | | | | | | | | | |
| C₁₂₋₁₄ Dimethyl- | 2 | 0.2 | 1 | 0.6 | 0 | 0 | 0 | 0 | 0 | 0 | 0 | 0 | 0 |
| hydroxyethylammonium | | | | | | | | | | | | | |
| chloride | | | | | | | | | | | | | |
| Sodium | 5 | 0 | 4 | 10 | 2 | 0 | 0 | 0 | 0 | 0 | 0 | 0 | 0 |
| tripolyphosphate | | | | | | | | | | | | | |
| Crystalline layered | 0 | 0 | 0 | 0 | 0 | 0 | 4 | 0 | 5 | 0 | 10 | 0 | 0 |
| silicate (—Na₂Si₂O₅) | | | | | | | | | | | | | |
| Silicate 2R | 0 | 0 | 0 | 0 | 0 | 0 | 2 | 0 | 1 | 0 | 10 | 0 | 0 |
| (SiO₂:Na₂O at ratio | | | | | | | | | | | | | |
| 2:1) | | | | | | | | | | | | | |
| 1.6R Silicate | 10 | 5 | 2 | 3 | 3 | 5 | 0 | 0 | 0 | 0 | 0 | 0 | 0 |
| (SiO₂:Na₂O at ratio | | | | | | | | | | | | | |
| 1.6:1) | | | | | | | | | | | | | |
| TAED | 0 | 3.2 | 2 | 4 | 1 | 0 | 0 | 3.2 | 2 | 1 | 1 | 0 | 0 |
| NOBS | 0 | 0 | 2 | 0 | 1 | 0 | 0 | 0 | 2 | 0 | 1 | 0 | 0 |
| Percarbonate | 0 | 14.1 | 15 | 20 | 10 | 0 | 0 | 14.1 | 15 | 10 | 10 | 0 | 0 |
| Zeolite A | 0 | 1 | 0 | 1 | 4 | 1 | 5 | 0 | 5 | 0 | 2 | 2 | 0.5 |
| Sodium carbonate | 25 | 20 | 25 | 15 | 18 | 30 | 15 | 20 | 4 | 20 | 23 | 30 | 23 |
| Acrylate Polymer | 1 | 0.5 | 4 | 1 | 1.5 | 1 | 1.1 | 3.7 | 1 | 3.7 | 2.6 | 3.8 | 4 |
| Soil release agent | 3 | 0 | 0 | 0 | 0 | 0 | 2 | 0.72 | 1 | 0.72 | 0 | 0 | 0 |
| Carboxymethylcellulose | 0.5 | 0 | 0 | 0 | 0 | 0 | 0.15 | 1.4 | 0.2 | 2 | 1 | 0.5 | 0.5 |
| PEG-PVAc Polymer | 0.1 | 0.2 | 0 | 4 | 0.05 | 0 | 0 | 0 | 0 | 0 | 0 | 0 | 0 |
| Protease (32.89 mg | 0.1 | 0.1 | 0.1 | 0.1 | 0.4 | 0 | 0.2 | 0.2 | 1 | 0.15 | 0.01 | 0.13 | 0.13 |
| active/g) | | | | | | | | | | | | | |
| Amylase—(8.65 mg | 0.3 | 0 | 0.1 | 0 | 0.1 | 0.1 | 0.2 | 0.001 | 0.2 | 0.4 | 0.15 | 0.15 | 0.15 |
| active/g) | | | | | | | | | | | | | |
| Lipase—(18 mg active/ | 0.03 | 0.07 | 0.3 | 0.1 | 0 | 1 | 0.05 | 0.15 | 0.1 | 0 | 0.001 | 0 | 0 |
| g) | | | | | | | | | | | | | |
| Cellulase—(15.6 mg | 0 | 0 | 0 | 0 | 0 | 0 | 0 | 0 | 0 | 0.001 | 0.1 | 0.1 | 0.2 |
| active/g) | | | | | | | | | | | | | |
| Fluorescent Brightener | 0.06 | 0 | 0.18 | 0.4 | 0.1 | 0.06 | 0 | 0.1 | 0.2 | 0 | 0.3 | 0 | 0 |
| Chelant | 0.6 | 2 | 0.6 | 0 | 0.6 | 0.6 | 0.2 | 0.5 | 2 | 0 | 0.2 | 0.4 | 0.2 |
| MgSO₄ | 0.3 | 1 | 1 | 0.5 | 1 | 1 | 0.42 | 0.42 | 4 | 0.42 | 0.4 | 0.2 | 0.4 |
| Perfume | 0.1 | 0.6 | 0.5 | 1.6 | 0.6 | 0.6 | 0.1 | 0.6 | 0.5 | 0.6 | 0.6 | 0.6 | 1 |
| Suds suppressor | 0.05 | 0.1 | 0 | 0.1 | 0.06 | 0.05 | 0.05 | 0.1 | 0 | 0.1 | 0.06 | 0.05 | 0.05 |
| agglomerate | | | | | | | | | | | | | |
| Soap | 0.45 | 0.45 | 0.45 | 1 | 0 | 0 | 0.25 | 0.45 | 0.45 | 1 | 0 | 0 | 0 |
| Sulphonated zinc | 0.1 | 0 | 0.0012 | 0.01 | 0.0021 | 0 | 0.0007 | 0.0012 | 0.0007 | 0.1 | 0.001 | 0 | 0 |
| phthalocyanine | | | | | | | | | | | | | |
| Hueing Agent | 0 | 0 | 0.0003 | 0.001 | 0.01 | 0.1 | 0 | 0.03 | 0.0001 | 0.0001 | 0 | 0 | 0.1 |

| | |
|---|---|
| Sulfate/Water & | Balance |
| Miscellaneous | |

All enzyme levels are expressed as % enzyme raw material.

### Example 8

### Liquid Bleach & Laundry Additive Detergent Formulations

Liquid bleach and/or laundry additive detergent compositions are made by mixing together the ingredients listed in the proportions shown in Table 8.

TABLE 8

| Ingredients | AF | AG | AH | AI | AJ | AK |
|---|---|---|---|---|---|---|
| Branched Sulfonate | 15 | 5.5 | 2 | 5.5 | 4 | 10 |
| AES | 11.3 | 6 | 15.4 | 12 | 8 | 10 |
| LAS | 10.6 | 6 | 2.6 | — | — | 16 |
| AE | — | — | 2 | — | — | — |
| Chelant | 2.5 | — | 1.5 | — | — | 4.0 |
| 1,2-propandiol | — | 10 | — | — | — | 15 |
| Soil release agent | 2.0 | | | | | |
| Ethoxylated Polyethylenimine | | 1.8 | | | | |
| Acrylate Polymer | | | 2.9 | | | |
| Acusol 880 (Hydrophobically | | | | 2.0 | 1.8 | 2.9 |
| Modified Non-Ionic Polyol) | | | | | | |
| Protease (55 mg/g active) | — | — | — | — | 0.1 | 0.1 |
| Amylase (30 mg/g active) | — | — | — | — | — | 0.02 |
| Perfume | — | 0.2 | 0.03 | 0.17 | — | 0.15 |
| Fluorescent Brightener | 0.21 | — | — | 0.15 | — | 0.18 |
| Water, other optional | to 100% | to 100% | to 100% | to 100% | to 100% | to 100% |
| agents/components* | balance | balance | balance | balance | balance | balance |

*Other optional agents/components include suds suppressors, structuring agents such as those based on Hydrogenated Castor Oil (preferably Hydrogenated Castor Oil, Anionic Premix), solvents and/or mica pearlescent aesthetic enhancer. All enzyme levels are expressed as % enzyme raw material.

### Example 9

### Powder Bleach & Laundry Additive Detergent Formulations

Powder bleach and/or laundry additive detergent compositions are made by mixing together the ingredients listed in the proportions shown in Table 9.

TABLE 9

| Ingredients | AL | AM | AN | AO |
|---|---|---|---|---|
| Branched Sulfonate | 1 | 2 | 5 | 10 |
| AES | 1 | — | — | 1 |
| LAS | 0.5 | — | 1 | 10 |
| AE | 0.25 | 1 | 2.5 | 2 |
| Chelant | 1 | — | 0.5 | — |
| TAED | 10 | 5 | 12 | 15 |
| Sodium Percarbonate | 33 | 20 | 40 | 30 |
| NOBS | 7.5 | 5 | 10 | 0 |
| Protease (32.89 mg active/g) | 0.1 | 0.1 | 0.01 | 0 |
| Amylase - (8.65 mg active/g) | 0.3 | 0 | 0.001 | 0 |
| Mannanase (4 mg/g active) | 0.2 | — | — | 0.02 |
| Cellulase (15.6 mg/g active) | 0.2 | — | 0.02 | — |
| Perfume | — | 0.2 | 0.03 | 0.17 |
| Fluorescent Brightener | 0.21 | — | — | 0.1 |
| Sodium Sulfate | to 100% | to 100% | to 100% | to 100% |
| | balance | balance | balance | balance |

All enzyme levels are expressed as % enzyme raw material.

### Example 10

### Hand Dish Washing Detergent Formulations

Liquid bleach and/or laundry additive detergent compositions are made by mixing together the ingredients listed in the proportions shown in Table 10.

TABLE 10

| Level (as 100% active) | AP | AQ | AR | AS |
|---|---|---|---|---|
| Sodium alkyl ethoxy sulfate | 20.0 | — | — | — |
| (C1213EO0.6S) | | | | |
| Sodium alkyl ethoxy sulfate | — | 18.7 | 10.3 | 16.7 |
| (C1014EO2S) | | | | |
| Branched Sulfonate of Invention | 2.9 | 5.0 | 8.0 | 2.7 |
| C₁₂₋₁₄ dimethyl Amine Oxide | 7.6 | 5.35 | — | — |
| Cocamido propyl betaine | — | — | 4.5 | 6 |
| Lutensol XP80 - 3-propyl | 0.45 | — | 0.8 | — |
| heptanol EO8 | | | | |
| AE-Neodol 91EO7 | — | 0.4 | — | — |
| PEI600-EO10-PO7 block polymer | — | 0.3 | — | — |
| Sodium Chloride | 1.2 | 1.0 | 0.8 | 0.8 |
| Poly Propylene Glycol (MW 2000) | 1 | 0.4 | 0.8 | 1.1 |
| Ethanol | 2 | 2.5 | 5 | 2 |
| Sodium Hydroxide | 0.24 | 0.2 | 0.25 | 0.18 |
| Minors (perfume, preservative, | to 100% | to 100% | to 100% | to 100% |
| dye) + water | balance | balance | balance | balance |
| pH (@ 10% solution) | 9.0 | 9.0 | 9.2 | 8.8 |

### Raw Materials for Examples

LAS is linear alkylbenzenesulfonate having an average aliphatic carbon chain length C₁₁-C₁₂ supplied by Stepan, Northfield, Ill., USA or Huntsman Corp. HLAS is acid form.

AES is C₁₂₋₁₄ alkyl ethoxy (3) sulfate, C₁₂₋₁₅ alkyl ethoxy (1.8) sulfate or C₁₄₋₁₅ alkyl ethoxy (2.5) sulfate, supplied by Stepan, Northfield, Ill., USA or Shell Chemicals, Houston, Tex., USA.

AE is selected from C₁₂₋₁₃ with an average degree of ethoxylation of 6.5, C₁₂₋₁₄ with an average degree of ethoxylation of 7, C₁₄₋₁₅ with an average degree of ethoxylation of 7, C₁₂₋₁₄ with an average degree of ethoxylation of 9 or C₉₋₁₁ with an average degree of ethoxylation of 7, all supplied by Huntsman, Salt Lake City, Utah, USA or Shell Chemicals, Houston, Tex., USA.

AS is a C₁₂₋₁₄ sulfate, supplied by Stepan, Northfield, Ill., USA.

C₁₀₋₁₂ and C₁₂₋₁₄ Dimethylhydroxyethyl ammonium chloride are supplied by Clariant GmbH, Germany.

C₁₂₋₁₄ dimethyl Amine Oxide is supplied by Procter & Gamble Chemicals, Cincinnati, USA.

Sodium tripolyphosphate is supplied by Rhodia, Paris, France.

Zeolite A is supplied by Industrial Zeolite (UK) Ltd, Grays, Essex, UK.

1.6R and 2.0R Silicate are supplied by Koma, Nestemica, Czech Republic.

Sodium Carbonate is supplied by Solvay, Houston, Tex., USA.

Acrylate Polymer is a polyacrylate molecular weight 4500 or Acrylic Acid/Maleic Acid Copolymer molecular weight 70,000 and acrylate:maleate ratio 70:30, supplied by BASF, Ludwigshafen, Germany.

PEG-PVAc polymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units. Available from BASF (Ludwigshafen, Germany).

Ethoxylated Polyethylenimine is a 600 g/mol molecular weight polyethylenimine core with 20 ethoxylate groups per —NH. Available from BASF (Ludwigshafen, Germany).

Zwitterionic ethoxylated quaternized sulfated hexamethylene diamine is described in WO 01/05874 and available from BASF (Ludwigshafen, Germany).

Grease Cleaning Alkoxylated Polyalkylenimine Polymer is a 600 g/mol molecular weight polyethylenimine core with 24 ethoxylate groups per -NH and 16 propoxylate groups per -NH. Available from BASF (Ludwigshafen, Germany).

Carboxymethyl cellulose is Finnfix® V supplied by CP Kelco, Arnhem, Netherlands.

Amylases (Natalase®, Stainzyme®, Stainzyme Plus®) may be supplied by Novozymes, Bagsvaerd, Denmark.

Lipases (Lipex®), Cellulases(Celluclean™), Mannanases (Mannaway®) and Xyloglycanases (Whitezyme®) may be supplied by Novozymes, Bagsvaerd, Denmark.

Proteases may be supplied by Genencor International, Palo Alto, Calif., USA (e.g. Purafect Prime®) or by Novozymes, Bagsvaerd, Denmark (e.g. Liquanase®, Coronase®).

Suitable Fluorescent Brighteners are for example, Tinopal® TAS, Tinopal® AMS, Tinopal® CBS-X, Sulphonated zinc phthalocyanine, available from BASF, Ludwigshafen, Germany.

Chelant is selected from, diethylenetetraamine pentaacetic acid (DTPA) supplied by Dow Chemical, Midland, Mich., USA, hydroxyethane di phosphonate (HEDP) supplied by Solutia, St Louis, Mo., USA; Ethylenediamine-N,N′-disuccinic acid, (S,S) isomer (EDDS) supplied by Octel, Ellesmere Port, UK, Diethylenetriamine penta methylene phosphonic acid (DTPMP) supplied by Thermphos, or 1,2-dihydroxybenzene-3,5-disulfonic acid supplied by Future Fuels Batesville, Ark., USA.

Hueing agent is Direct Violet 9 or Direct Violet 99, supplied by BASF, Ludwigshafen, Germany. Soil release agent is Repel-o-tex® PF, supplied by Rhodia, Paris, France.

Suds suppressor and suds suppressor agglomerate are supplied by Dow Corning, Midland, Mich., USA

Acusol 880 is supplied by Dow Chemical, Midland, Mich., USA.

TAED is tetraacetylethylenediamine, supplied under the Peractive® brand name by Clariant GmbH, Sulzbach, Germany.

Sodium Percarbonate and Sodium Carbonate are supplied by Solvay, Houston, Tex., USA.

NOBS is sodium nonanoyloxybenzenesulfonate, supplied by Future Fuels, Batesville, Ark., USA.

Sulphonated zinc phthalocyanine is available from BASF (Ludwigshafen, Germany).

1,2 propanediol, Monoethanolamine (MEA), Triethanolamine (TEA), Triisopropanolamine (TIPA) and Cyclohexyl dimethanol can be supplied by Dow Chemical Midland, Mich., USA

Diethylene glycol can be supplied by ME-Global (Dubai, United Arab Emirates)

Glycerol is supplied by Procter & Gamble Chemicals, Cincinnati, USA.

Sodium Cumene Sulfonate can be supplied by Stepan, Northfield, Ill., USA

C₁₂₋₁₈ Fatty Acid can be supplied by Wilmar, Singapore.

Citric Acid and Ethanol can be supplied by Tate and Lyle, London, England.

Borax can be supplied by US Borax Valencia, Calif., USA.

Lauryl Trimethyl Ammonium Chloride can be supplied by Evonik, Essen, Germany.

Sodium Formate and Calcium Formate can be supplied by Perstorp, Toledo, Ohio, USA.

Magnesium Sulfate can be supplied by PQ Corporation, Valley Forge, Pa., USA.

Calcium Chloride can be supplied by Tetra Technologies Woodlands, Tex., USA.

Crystalline layered silicate (—Na₂Si₂O₅) can be supplied as SKS®-6 Layer Silicate by Essential Ingredients Lawrenceville, Ga., USA.

Soap can be supplied as Soap Noodles and can be obtained from KLK, Malaysia.

Sodium Sulfate can be supplied by Searles Valley Minerals, Overland Park, Kans.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A surfactant composition comprising:
from about 5% to about 75%, by weight of the surfactant composition, of a surfactant system, the surfactant system comprising:
(a) a branched surfactant of the formula:
X−Y
wherein X is a hydrophobic branched saturated alkyl moiety, the alkyl moiety comprising:
(1) from about 9 to about 18 total carbons, on average, in the moiety;
(2) a longest linear carbon chain attached to the Y moiety, the longest linear carbon chain having, from about 8 to about 17 carbon atoms, on average; and
(3) one or more, on average, alkyl moieties (“branch moieties”) branching from the longest linear carbon chain, the branch moieties having from about 1 to about 3 carbon atoms, on average; and
wherein Y is a sulfonate moiety; and
(b) a non-sulfonated detersive surfactant;
wherein the weight ratio of (a):(b) is from about 5:95 to about 95:5.

2. A surfactant composition according to claim 1, wherein the longest linear carbon chain in the -X moiety has from about 10 to about 17 carbons.

3. A surfactant composition according to claim 1, wherein the longest linear carbon chain in the -X moiety has an average number of carbons that is from 12 to 13, from 14 to 15, or from 16 to 17.

4. A surfactant composition according to claim 1, wherein the branch moieties have from about 1 to about 2.5.

5. A surfactant composition according to claim 1, wherein a majority of the branch moieties are methyl groups.

6. A surfactant composition according to claim 1, wherein at least one of the branch moieties is attached directly to a carbon of the longest linear carbon chain located at position 2 or greater, wherein the carbon at position 1 is the carbon of the longest linear carbon chain attached to the -Y moiety.

7. A surfactant composition according to claim 6, wherein at least one of the branch moieties is attached directly to a carbon of the longest linear carbon chain located at a position in the range of from position 2 to position (ω−2), wherein the terminal carbon of the longest linear carbon chain is at positon ω.

8. A surfactant composition according to claim 1, wherein the X- moiety is not substituted with a sulphonate group.

9. A surfactant composition according to claim 1, wherein at least 30% of the branched surfactant includes branching moieties.

10. A surfactant composition according to claim 1, wherein Y is a non-alkoxylated sulfonate moiety.

11. A surfactant composition according to claim 1, wherein the non-sulfonated detersive surfactant is selected from the group consisting of anionic surfactant, nonionic surfactant, amphoteric surfactant, zwitterionic surfactant, and mixtures thereof.

12. A surfactant composition according to claim 1, wherein the non-sulfonated detersive surfactant is selected from the group consisting of alkyl alkoxylated sulfate surfactant, ethoxylated alcohol surfactant, amine oxide surfactant, quaternary ammonium surfactant, betaine surfactant, and mixtures thereof.

13. A surfactant composition according to claim 1, wherein the surfactant system further comprises alkyl benzene sulfonate surfactant.

14. A surfactant composition according to claim 1, the composition comprising from about 5% to about 50%, preferably from about from about 8% to about 30%, by weight of the surfactant composition, of the surfactant system.

15. A surfactant composition according to claim 1, the composition further comprising at least one detergent adjunct.

16. A surfactant composition according to claim 15, wherein the at least one detergent adjunct is selected from the group consisting of fatty acids and/or salts thereof, enzymes, encapsulated benefit agents, soil release polymers, hueing agents, builders, chelating agents, dye transfer inhibiting agents, dispersants, enzyme stabilizers, catalytic materials, bleaching agents, bleach catalysts, bleach activators, polymeric dispersing agents, soil removal/anti-redeposition agents, polymeric dispersing agents, polymeric grease cleaning agents, brighteners, suds suppressors, dyes, hueing agents, perfume, structure elasticizing agents, fabric softeners, carriers, fillers, hydrotropes, solvents, anti-microbial agents and/or preservatives, neutralizers and/or pH adjusting agents, processing aids, opacifiers, pearlescent agents, pigments, anti-corrosion agents, anti-tarnishing agents, and mixtures thereof.

17. A surfactant composition according to claim 1, wherein the surfactant composition is a hard surface cleaning composition or a fabric care composition.

18. A process of treating a fabric, the process comprising the step of contacting a fabric with the composition of claim 1, preferably in the presence of water.

19. A process of making a surfactant composition, the process comprising the steps of:
providing surfactants (a) and (b) as listed below,
where (a) is a branched surfactant of the formula:
X−Y
wherein X is a hydrophobic branched alkyl moiety, the alkyl moiety comprising:
(1) from about 9 to about 18 total carbons, on average, in the moiety;
(2) a longest linear carbon chain attached to the Y moiety, the longest linear carbon chain having from about 8 to about 17 carbon atoms, on average; and
(3) one or more alkyl moieties (“branch moieties”) branching from the longest linear carbon chain, the branch moieties having from about 1 to about 3 carbon atoms, on average; and
wherein Y is a sulfonate moiety; and
where (b) is a non-sulfonated detersive surfactant; and
combining (a) and (b) in a weight ratio of from about 5:95 to about 95:5.

20. A process of making a surfactant composition according to claim 30, the process further comprising the step of combining at least one detergent adjunct with (a) and/or (b) to form the surfactant composition.
